(19) United States
(12) Patent Application Publication
(10) Pub. No.: US 2014/0019162 A1
(43) Pub. Date: Jan. 16, 2014

(54) METHODS, SYSTEMS, AND DEVICES FOR ONLINE TRIAGE

(71) Applicant: KEONA HEALTH, INC., Chapel Hill, NC (US)

(72) Inventors: Jason Skowronski, Durham, NC (US); Jimmy Kaanapu, Chapel Hill, NC (US); Oakkar Oakkar, Chapel Hill, NC (US); Javed Mostafa, Cary, NC (US)

(21) Appl. No.: 13/940,079

(22) Filed: Jul. 11, 2013

Related U.S. Application Data
(60) Provisional application No. 61/671,027, filed on Jul. 12, 2012.

(51) Int. Cl. G06F 19/00; G06Q 50/24

(52) U.S. Cl. CPC G06F 19/322; G06Q 50/24
USPC 705/3

(57) ABSTRACT

An automated triage system may include a patient database, a patient information system, a prioritized ranking system, and a nurse control panel system. The patient information system can include a user interface module, a clinical decision rules database, and a data processing engine. The patient information system may collect patient information data from a patient and generate a clinical determination based on the collected data. The prioritized ranking system may be configured to process to clinical determination to determine a prioritized ranking score for the patient. The nurse control panel system may be configured to process the prioritized ranking score and rank and display the patients in a patient queue, highlight clinically pertinent information, and generate a template response with personalized health information to save the nurse time and improve quality of care.

### CROSS-REFERENCED TO RELATED APPLICATIONS

This application claims priority under 35 U.S.C. §119(e) to U.S. Provisional Application No. 61/671,027, entitled “METHODS, SYSTEMS, AND DEVICES FOR ONLINE TRIAGE” and filed on Jul. 12, 2012, which is hereby incorporated by reference in its entirety.

### BACKGROUND

1. Field

This disclosure generally relates to online triage and more particularly to improved methods and systems for prioritizing patients in a queue.

2. Description of the Related Art

Existing triage services can include telephone triage and automated symptom checkers on the internet. The strength of telephone triage is that it is well-established with a proven return on investment (ROI). Weaknesses of telephone triage are that they are not online, they do not connect to the patient's electronic health records (EHRs) or electronic medical records (EMRs), and they do not close the loop with the patient's provider. In fact, currently, when patients call the triage nurse and the nurse is not available, the calls are put into a queue. Few systems ensure that the calls are returned within a specified time frame. Furthermore, there is no way to identify and move urgent cases to the front of the queue other than by listening to the calls. Non-urgent problems can take several hours for a return call.

The strength of symptom checkers is that being online, they get higher utilization. Major symptom checkers also link to extensive libraries of online information, helping educate and empower patients. Weaknesses include recommendations not being reviewed by a physician, little in the way of safety check, and a lack of context for issues that professionals are good at uncovering. A symptom checker, for example, will not ask a patient, “So tell me how this happened?” A symptom checker, being automated, is not considered a reliable source for health recommendations. Nearly every symptom checker includes warnings like, “These recommendations should not be used as a basis for delaying, or as a substitute for, evaluation and treatment by a physician.” In fact, if a patient uses an online symptom checker, the patient's doctor will never know. The symptoms will never appear on the patient's chart and cannot be used by the patient's doctor to inform the patient on his or her next visit. Furthermore, most online symptom checkers, do a great job of combining recommendations with a wealth of information available at a click. However, usually the online symptom checks do too good a job. Doctors regularly report frustration with patients bringing in their own unguided research, where the patients are convinced that they have a rare disease when in fact they do not.

### SUMMARY

The systems and methods described herein can help patients make informed health decisions anywhere, with professional, personalized review. In an embodiment, the systems and methods described herein can put patients in control of their issue, saving patients their time and money and improving health outcomes.

The systems and methods described herein can revolutionize patient access for any provider that utilizes telephone triage, including nurse contact centers and provider groups. By automating patient intake, a nurse time savings of nearly 50% per encounter can be achieved. In certain embodiments, nurse time can be saved by between about 5% and 100%.

In some embodiments, by adding intelligent online means of access, the reach and effectiveness of nurses can be improved. The systems and methods described herein can enable providers to save time while engaging their patients by coming alongside the patient when the patient most needs it. In certain embodiments, advanced safety checks can be added to the triage process and, if an appointment is needed, the provider's access and admissions can be facilitated. The result is lower costs, improved outcomes, and/or smoother operations in certain embodiments.

In some embodiments, all the above can be provided using cutting-edge decision support backed by proven diagnostic protocols made available anywhere over the cloud.

In some embodiments, the systems and methods described herein offer a hybrid approach, combining the benefits of existing web and telephone triage systems. The systems and methods described herein allow patients to drive for the simple cases that make up the majority of their requests for medical help, and can use nurses as an escalation path for complex or unusual cases. This can offer significant cost savings over telephone triage, which requires a nurse for every case. At the same time, it can offer improved patient safety over existing web triage systems, which offer no integrated escalation path for nurses. In certain embodiments, the systems and methods described herein ensure most, if not all, cases will be reviewed within a specified time frame. Furthermore, the systems and methods described herein can red flag cases requiring more urgent nurse follow-up, enhancing response time and thus safety over current practice. Finally, patients may be more willing to report embarrassing conditions on a private, secure form rather than to a telephone triage nurse.

In some embodiments, the systems and methods described herein offers integration key to achieving the proposed safety and cost-savings goals. In certain embodiments, integration with the provider's Electronic Medical Record (EMR) can give access to the patient's history, which will guide the triage decision. The systems and methods described herein can allow us to provide a recommendation anytime, including appointment request time, the key patient decision point for realizing cost savings. Standard and well-accepted telephone triage protocols can provide the legal standard of care. Standards such as HL7, CCD, CCR can allow interoperability with EMR systems.

In some embodiments, the systematic, evidence-based approach to quality management ensures the highest possible standard for patient safety. In addition to the standard protocols and the systems and methods described above, extensive processes can be added in some embodiments for quality monitoring, case review by physicians, and/or error resolution. Moreover, in certain embodiments, integration with the EMR can be used to measure the sensitivity and specificity of symptom and history indicators from thousands of patients, and then improve the system over time. This quantity and quality of evidence can give a significant advantage over other triage systems, including the ability to continuously measure and improve the CDS using an evidence-based approach.

One aspect of this disclosure provides an automated triage system. The automated triage system comprises a patient database configured to store patient information data. The automated triage system further comprises a patient information system configured to receive patient information data from a user interface. The patient information system may comprises a user interface module configured to electronically connect over a secure network connection to a computing device configured to display the user interface to a patient, the user interface module configured to cause display of patient inquiries and to receive patient information data inputted by the patient though the user interface, the user interface module configured to electronically store the patient information data into the patient database. The patient information system may further comprise a clinical decision rules database comprising healthcare triage protocols configured to solicit patient information data and to provide clinical determinations. The patient information system may further comprise a data processing engine configured to access the healthcare triage protocols stored in the clinical decision rules database and to access the patient information data stored in the patient database and to apply the healthcare triage protocols to the patient information data to generate patient inquiries and to generate a clinical determination. The automated triage system further comprises a prioritized ranking system configured to electronically process the clinical determination to determine a prioritized ranking score for the patient. The automated triage system further comprises a nurse control panel system configured to electronically process the prioritized ranking score to determine a patient ranking relative to one or more other patients in a patient queue, the nurse control panel system configured to cause dynamic display of the patient queue, the nurse control panel system configured to access the patient database to cause display of patient information data of the patient.

Another aspect of this disclosure provides a computer-implemented method of automating a triage system. The method comprises, as implemented by one or more computer systems comprising computer hardware and memory, the one or more computer systems configured with specific executable instructions, electronically connecting over a network connection to a computing device configured to display a user interface to the user. The method further comprises receiving patient information data inputted by the user though the user interface. The method further comprises electronically storing the patient information data into a patient database. The method further comprises accessing healthcare triage protocols stored in a clinical decision rules database. The healthcare triage protocols may be configured to solicit patient information data and to provide clinical determinations. The method further comprises accessing the patient information data stored in the patient database. The method further comprises applying the healthcare triage protocols to the patient information data. Application of the healthcare triage protocols may generate patient inquiries and a clinical determination. The method further comprises electronically processing the clinical determination to determine a prioritized ranking score for the user. The method further comprises electronically processing the prioritized ranking score to determine a patient ranking relative to one or more other users in a patient queue. The method further comprises dynamically generating data to dynamically display the patient queue in a second user interface displayed by a second computing device.

Another aspect of this disclosure provides a non-transitory computer-readable medium comprising one or more program instructions recorded thereon, the instructions configured for execution by a computing system comprising one or more processors in order to cause the computing system to electronically connect over a network connection to a computing device configured to display a user interface to the user. The medium further comprises one or more program instructions recorded thereon to cause the computing system to receive patient information data inputted by the user though the user interface. The medium further comprises one or more program instructions recorded thereon to cause the computing system to electronically store the patient information data into a patient database. The medium further comprises one or more program instructions recorded thereon to cause the computing system to access healthcare triage protocols stored in a clinical decision rules database. The healthcare triage protocols may be configured to solicit patient information data and to provide clinical determinations. The medium further comprises one or more program instructions recorded thereon to cause the computing system to access the patient information data stored in the patient database. The medium further comprises one or more program instructions recorded thereon to cause the computing system to apply the healthcare triage protocols to the patient information data. The medium further comprises one or more program instructions recorded thereon to cause the computing system to generate patient inquiries and a clinical determination based on application of the healthcare triage protocols to the patient information data. The medium further comprises one or more program instructions recorded thereon to cause the computing system to electronically process the clinical determination to determine a prioritized ranking score for the user. The medium further comprises one or more program instructions recorded thereon to cause the computing system to electronically process the prioritized ranking score to determine a patient ranking relative to one or more other users in a patient queue. The medium further comprises one or more program instructions recorded thereon to cause the computing system to dynamically generate data to dynamically display the patient queue in a second user interface displayed by a second computing device.

### BRIEF DESCRIPTION OF THE DRAWINGS

Features and aspects, and advantages of the embodiments of the invention are described in detail below with reference to the drawings of various embodiments, which are intended to illustrate and not to limit the invention. The drawings include the following figures in which:

FIG. 1 is a block diagram depicting an exemplary communications system.

FIG. 2 is a more detailed block diagram depicting the exemplary communications system of FIG. 1.

FIGS. 3A-3B illustrate a more detailed block diagram depicting the insight engine server of the communications system of FIG. 1.

FIG. 4 illustrates a system diagram showing the major technology components of some embodiments using a different layout.

FIG. 5 illustrates the flexibility by which the insight engine server of the communications system of FIG. 1 can be integrated into existing EMR systems.

FIG. 6 illustrates the relationship between data, concepts, and rules.

FIG. 7A illustrates a user interface viewed by a patient using a triage device or a user device of the communications system of FIG. 1.

FIG. 7B illustrates a user interface viewed by a nurse using a triage device of the communications system of FIG. 1.

FIG. 7C illustrates another user interface viewed by a nurse using a triage device of the communications system of FIG. 1.

FIG. 7D illustrates another user interface viewed by a nurse using a triage device of the communications system of FIG. 1.

FIG. 8 illustrates a user interface viewed by a nurse using a triage device of the communications system of FIG. 1 when the nurse accesses the web application executed by the nurse triage express module of the insight engine server of the communications system of FIG. 1.

FIG. 9 illustrates another user interface viewed by a nurse using a triage device of the communications system of FIG. 1 when the nurse accesses the web application executed by the nurse triage express module of the insight engine server of the communications system of FIG. 1

FIGS. 10A-10B illustrate another user interface viewed by a nurse using a triage device of the communications system of FIG. 1 when the nurse accesses the web application executed by the nurse triage express module of the insight engine server of the communications system of FIG. 1

FIG. 11 illustrates another user interface viewed by a nurse using a triage device of the communications system of FIG. 1 when the nurse accesses the web application executed by the nurse triage express module of the insight engine server of the communications system of FIG. 1.

FIG. 12 illustrates a more detailed view of a patient history column.

FIGS. 13A-13B illustrate another user interface viewed by a nurse using a triage device of the communications system of FIG. 1 when the nurse accesses the web application executed by the nurse triage express module of the insight engine server of the communications system of FIG. 1.

FIGS. 14A-14B illustrate a more detailed view of a recommendation column.

FIGS. 14C-14D illustrate another user interface viewed by a nurse using a triage device of the communications system of FIG. 1 when the nurse accesses the web application executed by the nurse triage express module of the insight engine server of the communications system of FIG. 1.

FIG. 15 illustrates another user interface viewed by a nurse using a triage device of the communications system of FIG. 1 when the nurse accesses the web application executed by the nurse triage express module of the insight engine server of the communications system of FIG. 1.

FIG. 16 illustrates another user interface viewed by a nurse using a triage device of the communications system of FIG. 1 when the nurse accesses the web application executed by the nurse triage express module of the insight engine server of the communications system of FIG. 1.

FIG. 17 is a flowchart depicting an embodiment of a process for for automating a triage system.

FIG. 18 is block diagram depicting an embodiment of a more detailed device of the communications system of FIG. 1.

### DETAILED DESCRIPTION OF THE EMBODIMENT

### Overview

The proliferation of online health websites is not news to contact centers. Indeed, many contact centers have already invested in their own form of multichannel contact with patients. However, the systems and methods described herein can improve upon the systems developed by these contact centers. In some embodiments, an application allows patients to pre-populate their chief complaint and, in so doing, patient calls can be prioritized or ranked before the nurse touches the records. In certain embodiments, the application does not replace applications in place today. Instead, the application complements existing nurse triage infrastructure and offers integration with a provider's electronic medical records (EMR) to create seamless integration and flow of relevant patient history and detail. For example, the application involves the practitioner (e.g., doctor, physician, provider, etc.) in the patient's decision making process and documents the patient's answers for the practitioner in an easy to read format. As another example, the application can scan the patient's EMR record and summarize pertinent information for each case to the triage nurse.

In particular, the application offers several benefits. For example, nurses can get the benefit of complaint and health history before making outbound contact to patients. The result is that that nurses are better prepared to make care decisions and triage encounters are nearly 50% faster than current best practice in some embodiments. As another example, patients can get a sense of instant support by being able to immediately convey their chief complaint—no waiting for a nurse to come on the line in some embodiments. As another example, a patient can be given immediate feedback for most complaints and directions to the closest facility for urgent and/or emergent situations—some critical complaints may never be touched by the nurse in some embodiments. As another example, lower unit costs can be achieved via lower labor costs—call centers need not recruit, replace, train and/or hire as often as call centers do today in some embodiments. As another example, organizations seeking a patient or member-facing portal can get an immediate turnkey solution when the application is installed and privately labeled for their market in some embodiments. As another example, the application offers education guided by health professionals. In some embodiments, the systems and methods described herein uniquely combine medical knowledge and analytics to improve access and admissions.

### System Overview

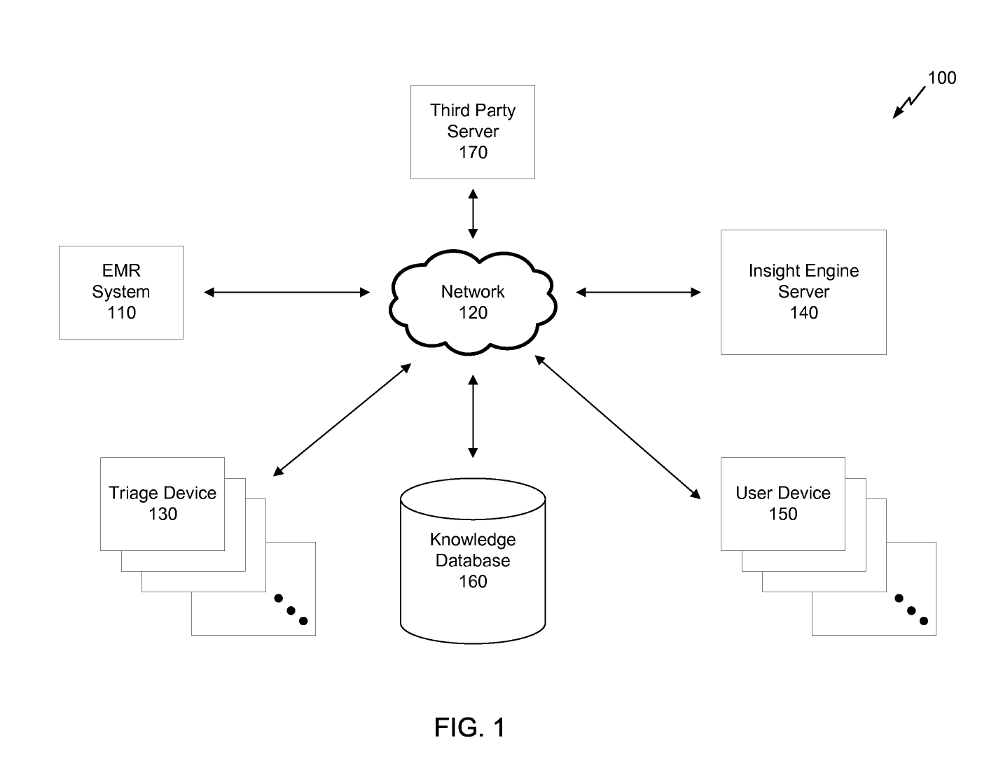

FIG. 1 is a block diagram depicting an exemplary communications system 100. The communications system 100 can include several devices, systems, and/or servers. For example, the communication system 100 can include an electronic medical records (EMR) system 110, one or more triage devices 130, an insight engine server 140, one or more user devices 150, a knowledge database 160, a third party server 170, and/or a network 120. The EMR system 110, the one or more triage devices 130, the insight engine server 140, the one or more user devices 150, the knowledge database 160, and/or the third party server 170 can all communicate via the network 120.

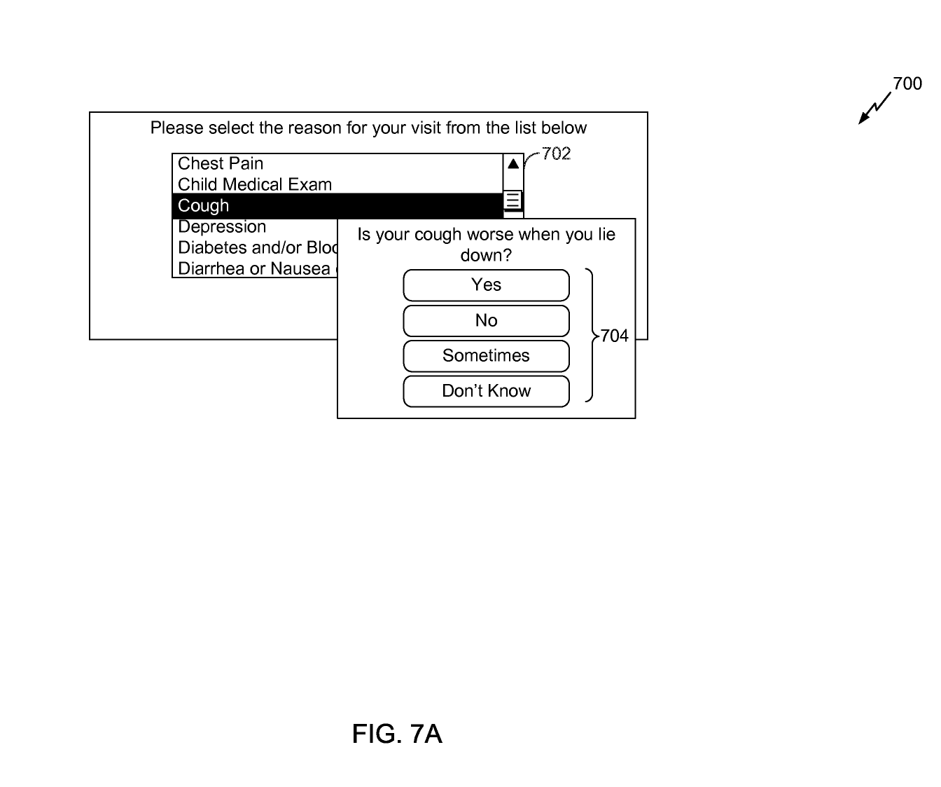

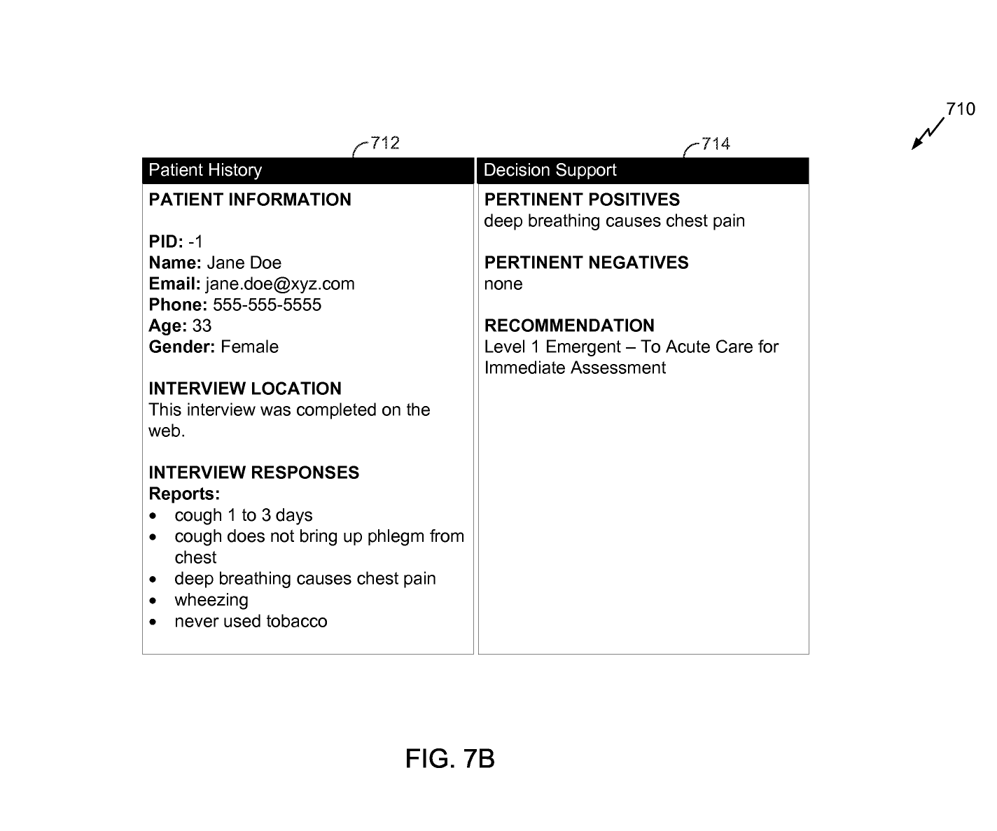

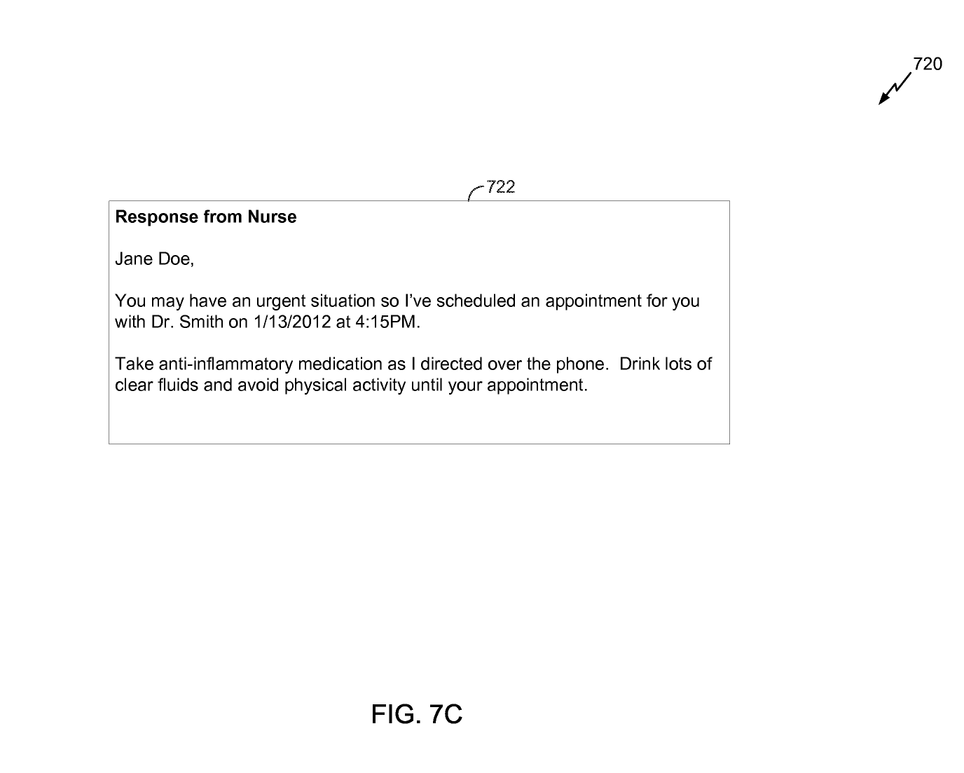

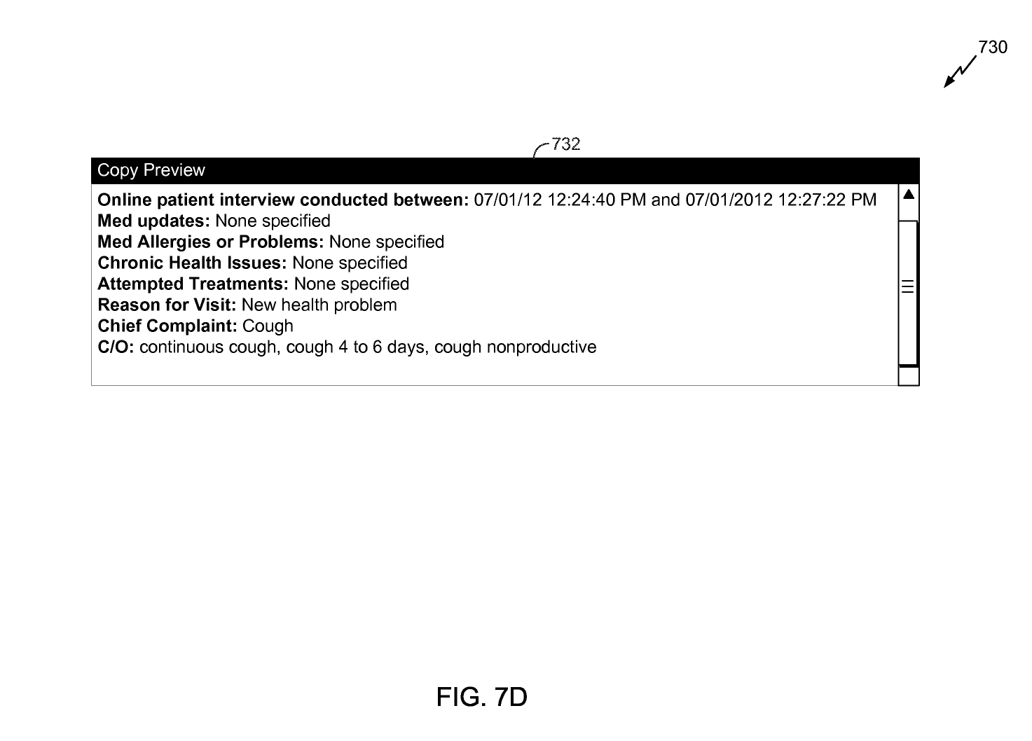

The EMR system 110 can be a system that monitors the medical history or medical data of a patient. The EMR system 110 can be accessed by a nurse or practitioner (e.g., doctor) and the EMR system 110 can be located at the practitioner's office, a hospital, or can be located remotely (e.g., in which case the practitioner can access the EMR system 110 via a remote portal, such as a web portal). In an embodiment, the EMR system 110 includes an interface, such as a graphical user interface, by which a practitioner can view information about a patient, upcoming appointments, lab results, and/or the like. In addition, the interface can include a window or pane that includes data provided by the insight engine server 140, which is described in greater detail below with respect to FIGS. 7A-16.

The one or more triage devices 130 can be located at the practitioner's office or a hospital. The one or more triage devices 130 can be a portal that allows a nurse to interact with the insight engine server 140. In particular, the portal allows a nurse to prioritize patients, contact patients, schedule appointments for patients, provide patients with information, and/or access and/or modify patient medical data stored by one or more EMR systems, such as the EMR system 110. The one or more triage devices 130 can also be a portal that allows a patient to provide information on medical symptoms and/or a reason that the patient is seeking medical care. For example, the one or more triage devices 130 can be a computer, tablet, or the like. The one or more triage devices 130 may be in communication with the insight engine server 140 in order to perform the operations described herein.

The insight engine server 140 (e.g., an automated triage system) can be a computing system that receives information from patients, compiles patient medical data, prioritizes (e.g., ranks) patients in a queue (e.g., a nurse queue), provides recommendations (e.g., recommended courses of action, urgency and level of care, articles describing self-care options, appointment scheduling information, etc.) to be reviewed by a nurse or practitioner and/or to be viewed by a patient, provides a mechanism for nurses or practitioners to contact patients, and/or provides updated information to EMR systems, such as the EMR system 110. For example, the insight engine server 140 can generate questions to be answered by patients (e.g., via the one or more triage devices 130 and/or the one or more user devices 150). Based on the answered questions and medical data pulled from one or more EMR systems, the insight engine server 140 can prioritize or rank the patient in a queue (e.g., a nurse queue) to determine the order in which the patient will receive attention from a nurse and/or generate recommendations for patients. The insight engine server 140 can also flag possible complications based on the answered questions and the medical data pulled from one or more EMR systems. Contact information for a patient can be provided by the insight engine server 140 to the one or more triage devices 130 to allow nurses to contact patients. Any updated data provided by a nurse via the one or more triage devise 130 can be sent to the insight engine server 140, which can then forward such data to one or more EMR systems, such as the EMR system 110, for storage. The insight engine server 140 is described in greater detail below.

The insight engine server 140 can utilize analytics to check patient symptoms and medical records against a database of safety checks. In certain embodiments, the insight engine server 140 creates needed reports and can learn as the number of cases grows. For example, the reports may include recommendations (e.g., recommended courses of action for a patient, urgency and level of care, articles describing self-care options, appointment scheduling information, etc.). As another example, the insight engine server 140 can measure sensitivity and specificity of symptoms and history indicators from a plurality of patients (e.g., thousands of patients) to improve the recommendations that are provided. In certain embodiments, the insight engine server 140 can interface with other patient portals and electronic health records or EMR systems, thereby reaching more patients and improving safety checks.

While the insight engine server 140 is illustrated as being a separate component, this is not meant to be limiting. In some embodiments, the insight engine server 140 can be integrated into the EMR system 110 and/or the third party server 170.

In an embodiment, the insight engine server 140 includes or is in communication with one or more storage mediums. For example, the insight engine server 140 can include or be in communication with one or more databases, such as the knowledge database 160.

The one or more user devices 150 can be any electronic device associated with a user, such as a patient. For example, the user device 150 can be a cell phone, laptop, tablet, desktop computer, and/or the like. The one or more user devices 150 can be configured to interact with the insight engine server 140. In particular, the one or more user devices 150 can be configured to receive questions generated by the insight engine server 140, receive information provided by nurses or practitioners via the one or more triage devices 130, and/or review scheduled appointments. In some embodiments, a patient can also perform the operations described above with respect to the one or more user devices 150 using the one or more triage devices 130.

The knowledge database 160 can include data related to the practice of medicine. For example, the data can include symptoms of various diseases, procedures or methods of treatment for various diseases, statistics collected from numerous patients across geographies and disease categories, and/or the like. In some embodiments, the knowledge database 160 can tie patient symptoms (which are rarely collected) to what happens when patients arrive at the doctor's office. Furthermore, all the data can be de-identified to protect patient privacy. The insight engine server 140 can retrieve data stored in the knowledge database 160 in order to generate a patient queue list and/or recommendations.

The third party server 170 can be an EMR-like computing system that stores and tracks medical data for one or more patients. In some embodiments, the insight engine server 140 transmits updated medical data to the third party server 170 in addition to, or instead of, the EMR system 110.

The EMR system 110, the one or more triage devices 130, and/or the one or more user devices 150 can be embodied as a computer system, such as, without limitation, a laptop, a desktop, a tablet, a smartphone, a cell phone, or the like.

The insight engine server 140 and/or the third party server 170 can be a computing device. For example, the insight engine server 140 and/or the third party server 170 can each include one or more processors to execute one or more instructions, memory, and communication devices to transmit and receive data over the network 120. In some embodiments, the insight engine server 140 and/or the third party server 170 are each implemented as one or more backend servers capable of communicating over a network. In other embodiments, the insight engine server 140 and/or the third party server 170 are each implemented by one more virtual machines in a hosted computing environment. The hosted computing environment can include one or more rapidly provisioned and released computing resources, which computing resources can include computing, networking and/or storage devices. A hosted computing environment can also be referred to as a cloud computing environment. In still other embodiments, the insight engine server 140 and/or the third party server 170 can each be represented as a user computing device capable of communicating over a network, such as a laptop or tablet computer, personal computer, personal digital assistant (PDA), hybrid PDA/mobile phone, mobile phone, global positioning system (GPS) device, or the like. Although FIG. 1 depicts a single insight engine server 140 and a single third party server 170, the functions described herein can be performed or distributed across multiple networked computing devices, including devices that are geographically distributed and/or are allocated dynamically from a pool of cloud computing resources. For example, the insight engine server 140 and the third party server 170 can each be implemented by one more virtual machines in a hosted computing environment. The hosted computing environment can include one or more rapidly provisioned and released computing resources (e.g., dynamically-allocated computing resources), which computing resources can include computing, networking and/or storage devices.

The network 120 can be a wired network, a wireless network, or a combination of the two. For example, the network 120 can be a personal area network, a local area network (LAN), a wide area network (WAN), or combinations of the same. Protocols and components for communicating via any of the other aforementioned types of communication networks, such as the TCP/IP protocols, can be used in the network 120.

In an embodiment, the devices and/or servers of the communications network 100 can be in communication with network 120 via wired or wireless technology. For example, devices and/or servers of the communications network 100 can communicate with network 120 via Ethernet, USB 1.0, USB 2.0, USB 3.0, IEEE 1394, IEEE 1394a, IEEE 1394b, Thunderbolt, VGA, DVI, HDMI, optical fiber, serial port, parallel port, the 802.11 standard, the 802.15.4 standard, radio-frequency identification (RFID), near-field communication (NFC), Bluetooth, or the like.

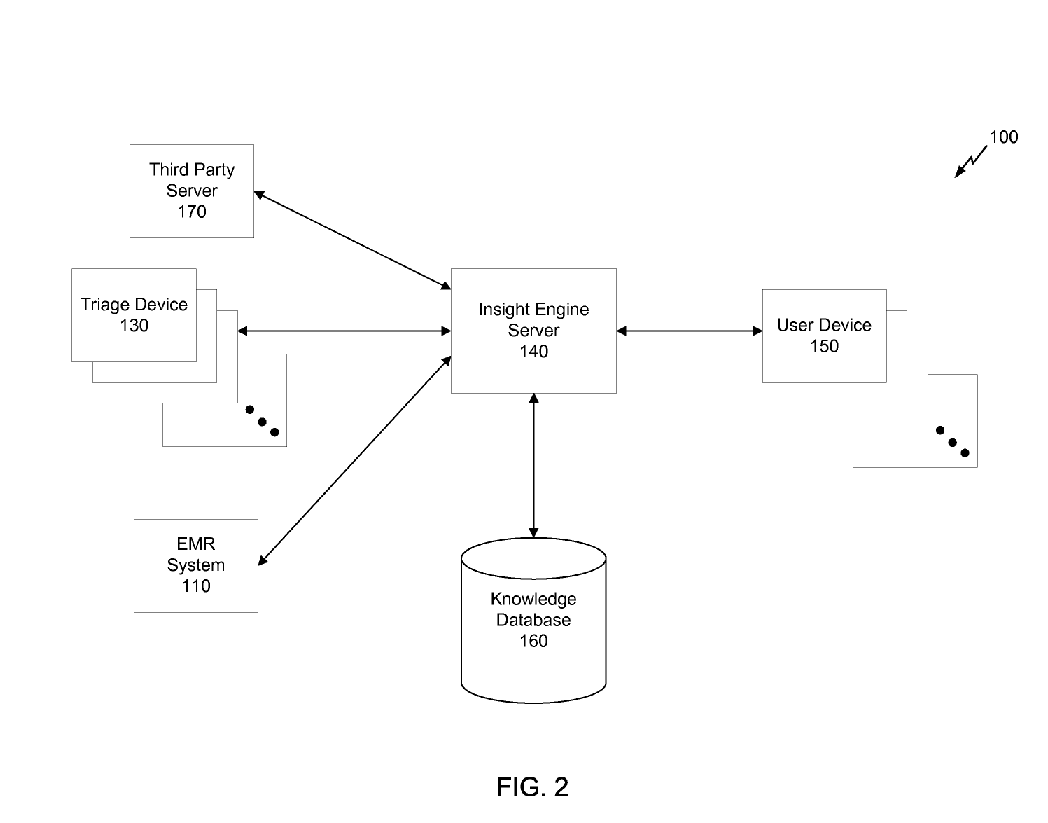

FIG. 2 is a more detailed block diagram depicting the exemplary communications system 100. As illustrated in FIG. 2, the EMR system 110, the one or more triage devices 130, the one or more user devices 150, the knowledge database 160, and the third party server 170 can all communicate with the insight engine server 140 directly or via the network 120 (not shown). The insight engine server 140 and the other components of the communications system 100 may communicate with each other to perform the operations described herein.

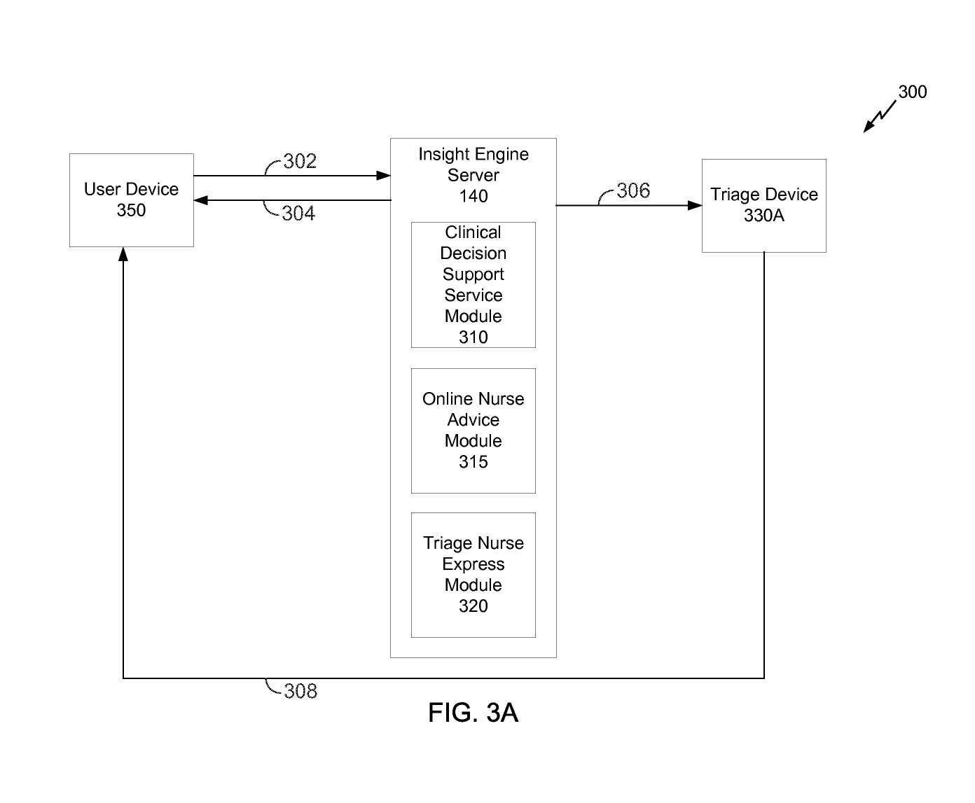

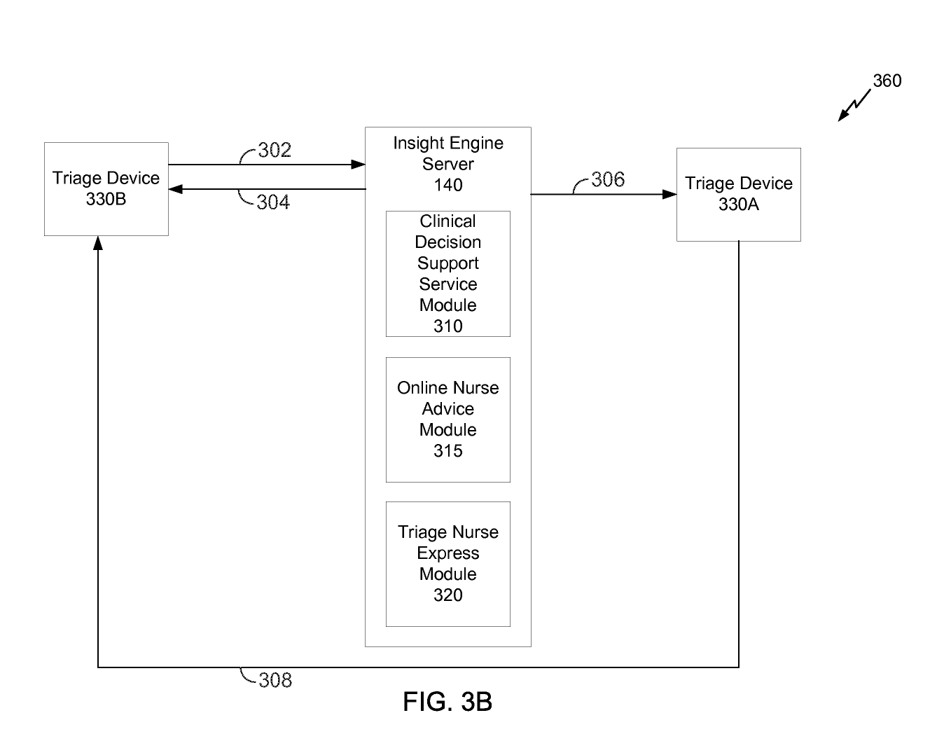

FIGS. 3A-3B illustrate a more detailed block diagram depicting the insight engine server 140. As illustrated in FIGS. 3A-3B, the insight engine server 140 comprises a clinical decision support service module 310, an online nurse advice module 315, and a triage nurse express module 320.

In an embodiment, the clinical decision support service module 310 (e.g., a data processing engine, a prioritized ranking system, etc.) is configured to facilitate the nurse or practitioner in making recommendations to the patient. The clinical decision support service module 310 may use proven diagnostic protocols (e.g., from a clinical decision rules database) to facilitate the nurse or practitioner in making recommendations to the patient. In some embodiments, the diagnostic protocols used by the clinical decision support service module 310 can be automatically updated (e.g., via the network 120 and an external database, not shown) as the standards and/or protocols are revised by the standards and/or protocols bodies. In addition, the clinical decision support service module 310 may use patient data acquired by the online nurse advice module 315 to facilitate the nurse or practitioner in making recommendations to the patient.

In some embodiments, the clinical decision support service module 310 is configured to implement triage protocols and provide emergency screening and prioritization (or ranking) of encounters (e.g., patients). The clinical decision support service module 310 can implement a variety of protocols, including the Wolters Kluwer telephone triage protocols and the Schmitt Thompson protocols, among others. The clinical decision support service module 310 can be built on top of the OpenCDS platform. In certain embodiments, the clinical decision support service module 310 accepts input in a data format such as a Continuity of Care Document (CCD) or Virtual Medical Record (VMR). The clinical decision support service module 310 can then use rules to map this data to clinical concepts, which allow for data normalization of both the syntax and semantics, as well as merging from multiple sources. The protocols can be implemented as rules that act upon the clinical concepts. These rules can specify things like triage level, which is used for emergency screening and/or prioritization (or ranking). For example, a patient's symptoms can be mapped to specific clinical concepts, and rules applied to the specific clinical concepts may specify a triage level for that patient. Triage levels of patients can then be compared to perform emergency screening and/or prioritization or ranking of the patients (e.g., the more critical or serious the triage level, the higher the patient will be prioritized or ranked). Emergency screening can tell patients at the end of the interview to seek urgent care or call 911 right away if they have an emergent condition. Prioritization or ranking can separate encounters needing immediate attention from a nurse from those that can wait for a specified time period. The rules can also be used to implement a template response 722 (e.g., an email 722) with personalized health information based on the patient's complaint.

In an embodiment, the online nurse advice module 315 (e.g., a user interface module) is a web application executed by the insight engine server 140 and accessible by a patient via the one or more triage portals 130 and/or the one or more user devices 150. The online nurse advice module 315 is configured to collect patient data based on an interview of the patient (e.g., based on answers provided by the patient when presented with a series of questions). Such patient data can include a patient's problem list (e.g., a list of symptoms experienced by the patient) and a medication list (e.g., medications currently taken by the patient, taken by the patient in the past, to be taken by the patient in the future, etc.).

In an embodiment, the triage nurse express module 320 (e.g., a nurse control panel system) is a web application executed by the insight engine server 140 and accessible by a nurse or practitioner via the one or more triage portals 130. The triage nurse express module 320 is configured to reduce the amount of time it takes a nurse or practitioner to review a patient report, which can include at least one recommendation generated by the clinical decision support service module 310. In particular, the triage nurse express module 320 is configured to collect and summarize information nurses need to make a decision. In some embodiments, the triage nurse express module 320 can red flag cases requiring a more urgent follow-up by a nurse or practitioner. Nursing staff, via the one or more triage portals 130, can set criteria specifying deadlines and red flags based on patient indicators and/or history. In certain embodiments, if the specified deadline is approaching and the nurses have still not reviewed the patient report, the triage nurse express module 320 can send an alert to the nurse's mobile device or email reminding the nurse to review the patient report. This can help ensure that all patient reports are reviewed in a timely manner. Additionally, in some embodiments, the functionality of the triage nurse express module 320 can be integrated into a quality management process. For example, when a nurse overturns a recommendation generated by the clinical decision support service module 310, the decision can be automatically recorded in a quality dashboard and trigger a case review process, which are described in greater detail below.

As illustrated in FIG. 3A, communications system 300 includes user device 350, the insight engine server 140, and a triage device 330A. In an embodiment, patients can use the user device 350 to complete predetermined interview questions, generated by the insight engine server 140 (e.g., the online nurse advice module 315), and to describe additional information or questions in written form for review by a nurse. For example, the patient can use the user device 350 to access the online nurse advice module 315. The answers generated by the patient can be transmitted to the insight engine server 140 via message 302. This can allow patients to identify the chief complaint, or the reason for their visit.

In certain embodiments, if the reason is a medical problem, the insight engine server 140 can generate follow-up questions about symptoms and history in order to make recommendations. Recommendations may include, but are not limited to, urgency and level of care, articles describing self-care options, appointment scheduling information, and/or the like. Although the nurses may respond quickly, patients may be instructed that responses from nurses may appear within a set number of hours (e.g., 5 business hours). If the patient needs immediate medical attention, the patient can use a walk-in clinic in certain embodiments. In some embodiments, patients with life threatening emergencies are instructed to call 911 (e.g., via message 304). In certain embodiments, patients who seek care advice using the user device 350 and the insight engine server 140 will not receive delayed care compared to the option of calling and scheduling a same day appointment with a scheduling secretary.

In some embodiments, a nurse can use the triage device 330A to monitor the queue and be responsible for reviewing the data collected by the insight engine server 140 via the user device 350. The nurse can review cases within a pre-specified time appropriate for the safety of patients, using the priority level as a guide, but not relying on it. In certain embodiments, the nurse has the responsibility of communicating with the patient over telephone, secured messages, and/or in-person, as needed to ensure the patient's safety. For example, such communications could occur via message 308 from the triage device 330A to the user device 350. The nurse can correct errors, clarify questions, and/or provide missing information as appropriate via message 308.

In some embodiments, once complete and correct information has been provided by the patient via message 302, a nurse can receive suggestions from the insight engine server 140 via message 306. The suggestions can include, but are not limited to, level of care and/or care instructions. However, in certain embodiments, the nurse may be responsible for independently reviewing the available information and independently providing the appropriate triage recommendation to patients. In some embodiments, recommendations generated by the clinical decision support service module 310 for the nurse are generated using a questionnaire provided to the user device 350, previous EMR history, and/or a customized or standardized industry-accepted protocol. The triage device 330A can display the recommendations to nurses. This can allow nurses to view the recommendation and take it into account when deciding whether to schedule an appointment with the practitioner or choose a less costly alternative (e.g., self-care). In some embodiments, the nurse may not use or communicate to the patient the level of care suggested by the clinical decision support service module 310. For example, if the suggested level of care varies in any way from the professional judgment of the nurse, then the nurse may not follow the recommendation generated by the clinical decision support service module 310. The nurse can also ensure information that needs to be synced with the EMR system 110 is entered correctly using the triage device 330A.

In some embodiments, after the review is complete, the patient will be sent the information the nurse provided via message 308, including, but not limited to, appointment information, educational materials, and/or care instructions. If it becomes apparent that a question is commonly misunderstood, or requires further clarification, the nurse or practitioner may decide to change the wording and/or add additional clarifying questions. In certain embodiments, case data will be copied to the EMR system 110. This data can include, but is not limited to, the patient-entered data from the interview as well as the nurse-entered triage notes and patient instructions. In some embodiments, the case data is formatted for each EMR system 110 using an appropriate template. Providers can review this data in the EMR system 110 before seeing the patient in the exam room as a way to prepare for the case mentally and streamline their line of questioning. In certain embodiments, after the practitioner has examined the patient and provided an actual diagnosis, that information can be used by the insight engine server 140 to track quality measures and improve accuracy of the clinical decision support service module 310 recommendations.

As illustrated in FIG. 3B, communications system 360 includes a triage device 330B, the insight engine server 140, and the triage device 330A. In an embodiment, the patient can use a triage device 330B instead of the user device 350 to perform the operations described above with respect to FIG. 3A. In other embodiments, not shown, the patient can use the triage device 330A instead of the user device 350 or the triage device 330B to perform the operations described above with respect to FIG. 3A.

In some embodiments, as described above, the insight engine server 140 can perform case reviews of encounters where the recommendation between the nurse and the clinical decision support service module 310 is discordant, and suggest improvements in an embodiment of the case review process described below. For example, once a discordant recommendation is identified, a technical case review can be completed (e.g., by the insight engine server 140), a physician case review can be completed (e.g., by a practitioner), potential errors can be identified based on the two reviews, the insight engine server 140 can be updated (e.g., the system firmware or software can be updated) if any errors are identified, and the updated system firmware or software can be transmitted to the various insight engine servers 140 and/or provided to technicians managing the various insight engine servers 140.

In certain embodiments, the case reviews can determine whether the discordant recommendation was clinically relevant, whether an error was made by the clinical decision support service module 310 or nurse, and/or whether the patient would have been at risk for an adverse event. In some embodiments, the case review can also classify the type of error as technical or clinical. Technical errors, such as the clinical decision support service module 310 missing a risk factor for urinary tract infection (UTI), can be reduced or eliminated by improving the firmware, software, or protocol. Clinical errors can be defined as discordant recommendations between the clinical decision support service module 310 and nurse that are determined to be clinically relevant, and are not fixable through a technical change to the clinical decision support service module 310. For example, it is not a clinical error if the discordance is primarily due to an ambiguous disease state, but it is a clinical error if the nurse forgot to ask the patient about a critical risk factor. In some embodiments, if there is a discordant professional opinion between the nurse and case reviewer, the most conservative and safest option for the patient may be preferred. In certain embodiments, the rates and types of errors can be included in the quality dashboard.

In some embodiments, the quality dashboard is configured to include key metrics to be monitored through a trial, such as safety and adverse events. The quality dashboard can be updated daily. The metrics can include, but are not limited to, safety, service utilization, cost savings, patient participation, patient compliance, call volume, rate of reporting for various disease categories, errors from case review, and adverse events among others.

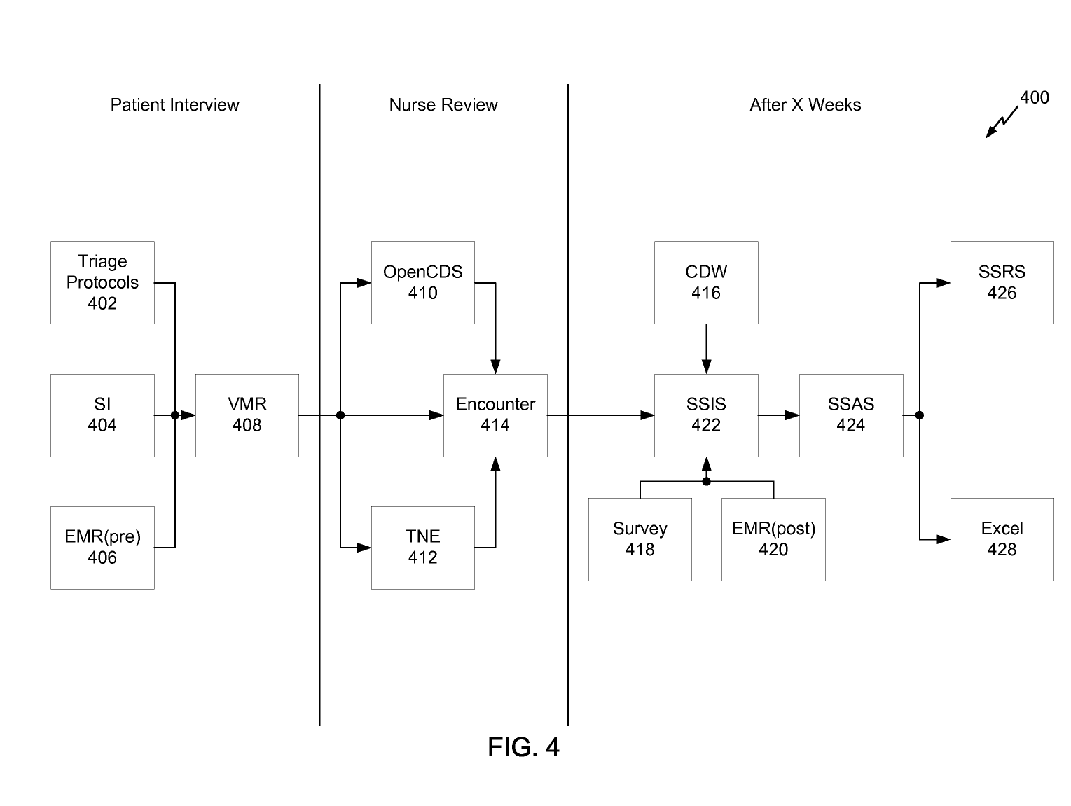

FIG. 4 illustrates a system diagram 400 showing the major technology components of some embodiments using a different layout. System diagram 400 illustrates three stages: patient interview, nurse review, and actions taken after a set number of weeks (e.g., two weeks). In an embodiment, triage protocols 402, smart intake (SI) 404, and EMR(pre) data 406 can be combined during the patient interview stage. For example, SI 404 can include data derived from patients or entered by patients (e.g., from patients using the one or more user devices 150 and/or the one or more triage devices 130), as described above. Such data can include, but is not limited to, a history of present illness, updates to the patient's electronic health record, and/or prescription refill or appointment requests. The EMR(pre) data 406 can be any data from any EMR system, such as Allscripts, Athenahealth, Epic, eCW, etc. The data can be combined into VMR 408 data.

In certain embodiments, data collected during the patient interview process can feed into the clinical decision support service module 310 and be shown to nurses using the web application executed by the triage nurse express module 320. For example, VMR 408 can feed into openCDS 410 (e.g., the clinical decision support service module 310) and/or triage nurse express (TNE) 412. Data generated by the openCDS 410 and/or the TNE 412 can be combined in encounter 414.

These encounters can also flow into the insight engine server 140. For example, data from encounter 414 can flow into, for example, Microsoft SQL Server Integration Services (SSIS) 422. Data from encounter 414 can also be merged with data from survey 418 (e.g., data from surveys presented to the nurse and/or patient), EMR(post) 420 (e.g., any EMR system), and/or CDW 416.

Data from SSIS 422 can be transmitted to, for example, Microsoft SQL Server Analysis Services (SSAS) 424. Data at SSAS 424 can be exported into various formats, such as an excel spreadsheet format (e.g., excel 428) or Microsoft SQL Server Reporting Services (SSRS) 426.

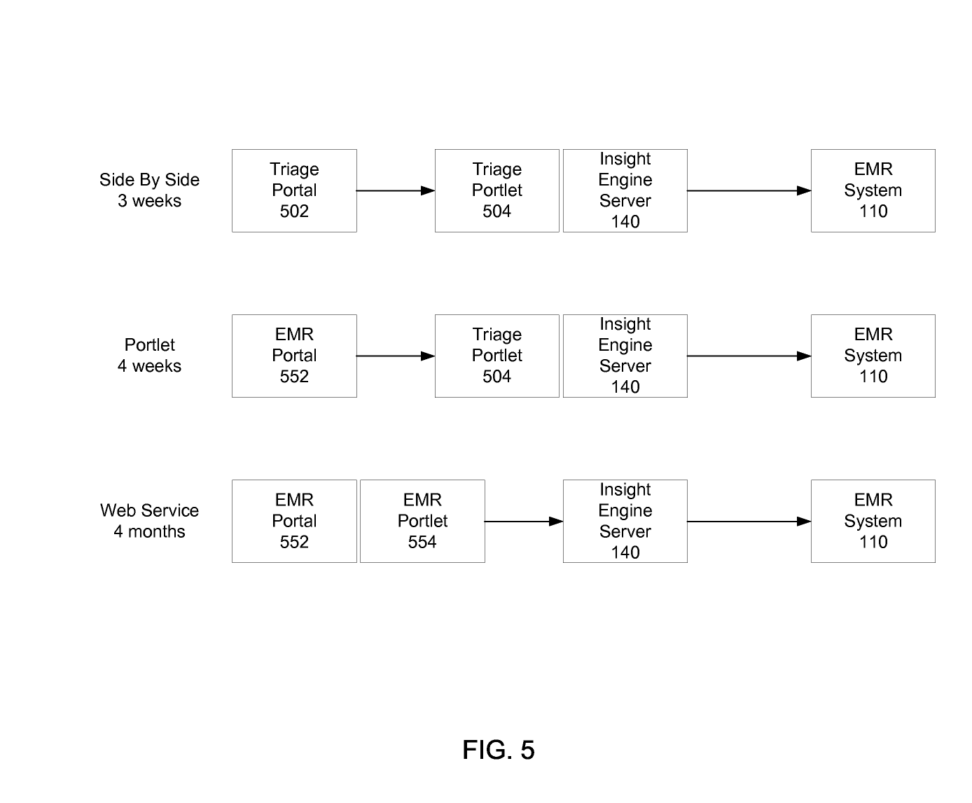

FIG. 5 illustrates the flexibility by which the insight engine server 140 can be integrated into existing EMR systems 110. In an embodiment, the insight engine server 140 can operate independently (e.g., via the use of a triage portal 502 and a triage portlet 504) and optionally call the EMR system 110 internal record service for data. For example, the triage portal 502 can call the triage portlet 504, which causes the insight engine server 140 to transmit data to the EMR system 110. In another embodiment, EMR systems 110 can plug the insight engine server 140 into their existing platform, either as white label implementation or by following an application store or application marketplace model. For example, an EMR portal 552 of the EMR system 110 calls the triage portlet 504 of the insight engine server 140, which then transmits data back to the EMR system 110. In another embodiment, larger EMR systems 110 may maintain their own user interfaces and just call the insight engine server 140 services for backend processing (e.g., via the use of the EMR portal 552 and an EMR portlet 554). For example, the EMR portal 552 and/or the EMR portlet 554 of the EMR system 110 can call the insight engine server 140, which then transmits data to the EMR system 110.

In some embodiments, many types of data can be read from an EMR system 110 (or an electronic health records (EHR) system). One type is the Continuity of Care Document (CCD), which can be passed from the EMR system 110 through an HL7-compliant interface. This can allow the insight engine server 140 to access data, such as the patient's problem list and medication list. The insight engine server 140 can ask the patient to update this information when completing the interview when accessing the web application executed by the online nurse advice module 315. In certain embodiments, updates to this data can be reviewed by a nurse before being copied back to the EMR system 110. The insight engine server 140 can also create clinic note templates, which format the data collected from the patient and nurse using the same layout and style as the EMR system 110. In some embodiments, this note can be put on a clipboard with a single click and pasted by the nurse into the EMR system 110 in a telephone or web encounter. This can provide documentation for legal purposes as well as for the practitioners to review before the patient's visit. Generating this documentation with help from the patient can save the nurses a lot of time because otherwise the nurses would have to collect such data over the phone and type it themselves into the EMR system 110.

In some embodiments, EMR systems 110 with more sophisticated interfaces or APIs provide ways to automatically write the data into the record without the extra click from the nurse or need to switch screens. This can also be done through the HL7-compliant interface, through web services APIs provided by the EMR system 110, writing to the clinical data repository database, and/or other methods. When the insight engine server 140 is partnered with an EMR system 110 and/or integrated internally into an EMR system 110, internal APIs can be used. While providers are likely to use EMR systems 110 as the destination system, contact centers may prefer to use their own contact center software (e.g., software executed by the third party server 170) and both types can be integrated. Contact center software is often specialized for contact centers and support triage functionality directly in the tool, including triage protocols. Examples include RelayHealth's RelayCare and LVM's Centaurus. The insight engine server 140 can make use of a clinical concept mapping technique to map the object identifiers in the insight engine server 140 to the identifiers of the destination system when inserting the encounter. The insight engine server 140 can also call appropriate APIs to insert encounters into the queue of the destination system so nurses can be notified and respond to cases in their usual user interface. The API may provide a way for the encounter to advance to the appropriate stage in the workflow so the nurse does not have to re-enter information the patient already entered. Again, this can help save the nurse additional time and allows for a single repository of data.

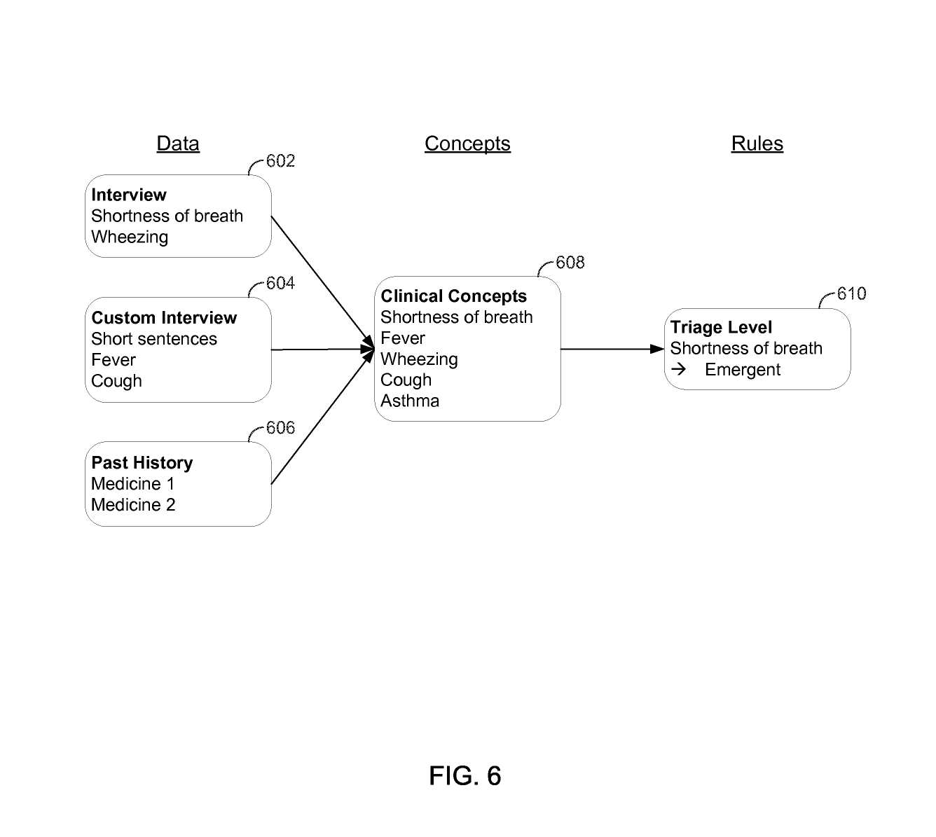

FIG. 6 illustrates the relationship between data, concepts, and rules. As illustrated in FIG. 6, interview data 602 includes shortness of breath and wheezing, custom interview data 604 includes short sentences, fever, and cough, and past history data 606 includes medicine 1 and medicine 2 (e.g., medicines taken by the patient in the past). Clinical concepts 608 includes shortness of breath, fever, wheezing, cough, and asthma. Triage level rules 610 includes shortness of breath, which results in an emergent triage level.

As described above, in some embodiments, the insight engine server 140 (e.g., the clinical decision support service module 310) implements triage protocols and provides emergency screening and prioritization of encounters. The insight engine server 140 can implement a variety of protocols and use rules to map data to clinical concepts, which allow for data normalization of both the syntax and semantics, as well as merging from multiple sources. For example, as illustrated in FIG. 6, interview data 602, custom interview data 604, and past history data 606 can be mapped to clinical concepts 608. The protocols can be implemented as rules that act upon the clinical concepts. These rules can specify things like triage level, which is used for emergency screening and/or prioritization. For example, the protocols, when acting upon the clinical concepts 608, leads to triage level 610.

In some embodiments, the insight engine server 140 provides insight to make better decisions faster, and can even automate critical process steps. The insight engine server 140 can automatically collect and generate clinical documentation, recommend which kind of practitioner, when to schedule the appointment, and/or provide educational articles among others. This can turn triage into a 1-click operation for the most common cases, can give patients better service, and/or can save providers a significant amount of money.

In some embodiments, the insight engine server 140 personalizes recommendations to patients based on their present and past medical history, giving better quality answers to patients and nurses. The insight engine server 140 can automatically suggest articles from a health library for each patient's encounter based on their current problem and/or past medical history. Nurses can change or offer additional articles they think are important for the patient to read.

In some embodiments, the insight engine server 140 analyzes thousands of de-identified cases across geographies and disease categories to offer better insight, and can even calculate the true return on investment for customers. The insight engine server 140 can show the needs of patient populations, provider performance, practice efficiency, cost savings, and/or trends. Select metrics can be made available to third parties (e.g., the third party servers 170) through a web service.

In some embodiments, the insight engine server 140 can track a variety of metrics including, but not limited to, the following operational, business, and/or clinical performance metrics: decision support concordance, interview completeness, review time, visit frequency, patient satisfaction, nurse satisfaction, and/or care redirection.

In some embodiments, the insight engine server 140 can use data collected along with a retrospective extraction of matching medical records to run simulations of the automated clinical decision support service module 310. The insight engine server 140 can compare the recommendation of the clinical decision support service module 310 to that of the nurse to measure decision support concordance.

In some embodiments, the insight engine server 140 can determine how complete and comprehensive the interview questions are (e.g., interview completeness) by calculating the percentage of encounters where the nurse required additional information from the patient, as indicated in the triage notes.

In some embodiments, the insight engine server 140 can measure the speed of the triage nurse's review process (e.g., review time) by calculating the mean review time for encounters in the triage nurse express module 320, and then compare that to the mean review time for telephone and in-person triage.

In some embodiments, the insight engine server 140 can also determine if the self-care instructions impact the frequency of visits (e.g., visit frequency). The insight engine server 140 can do this by comparing their visit frequency of patients who received the self-care instructions with those who did not.

In some embodiments, the insight engine server 140 can measure patient satisfaction by e-mailing patients a survey one week (or any amount of time) after their triage encounter. The survey may also ask additional questions about their experience.

In some embodiments, the insight engine server 140 can host focus groups with nurse triage staff to determine their satisfaction (e.g., nurse satisfaction) with the insight engineer server 140 system, and suggestions for improvement.

In some embodiments, the insight engine server 140 can measure and compare patient's self-assessment of severity to the triage nurse's (e.g., care redirection).

FIG. 7A illustrates a user interface 700 viewed by a patient using a triage device, such as the one or more triage devices 130, or a user device, such as the one or more user devices 150. As illustrated in FIG. 7A, a patient is presented with a branching list of questions (e.g., a survey) about the problem(s) he or she is experiencing. For example, the patient can choose a reason for a visit from a list 702 of possible reasons, and answer a follow-up question by entering text and/or choosing from a list 704 of possible answers. The fact that the questions are standardized can help the nurse not miss important questions. In some embodiments, the questions adhere to a standard protocol, such as the Schmitt-Thomson protocol, which helps reduce liability concerns.

FIG. 7B illustrates a user interface 710 viewed by a nurse using a triage device, such as the one or more triage devices 130. In certain embodiments, once a patient has completed the survey, the information associated with the patient shows up in a nurse queue according to the patient's priority. In some embodiments, the insight engine server 140 provides the nurse with a succinct summary 712 of the patient's contact information, biographical data, medical history, and/or answers including, but not limited to, affirmations and denials. This thorough list can be important for liability purposes and reduces nurse review time.

In certain embodiments, the insight engine server 140 also flags possible complications in decision support window 714. As illustrated in FIG. 7B, the report of difficulty breathing is highlighted at the top of the decision support window 714 so that the nurse can see and address the issue immediately.

FIG. 7C illustrates another user interface 720 viewed by a nurse using a triage device, such as the one or more triage devices 130. In some embodiments, the nurse will typically call the patient, and then reply to the patient with a secure template response 722 (e.g., a secure email 722). Email 722 can be generated by the insight engine server 140 and include instructions, maps, and/or educational content selected for the patient by the nurse or personalized for the patient by the insight engine server 140. For example, if the user reports symptoms consistent with an upper respiratory infection, the user interface 720 and/or the email 722 can automatically display articles about colds and flus to be reviewed by the nurse before being sent to the patient. In certain embodiments, the insight engine server 140 automatically tracks whether the email 722 was read or not, allowing the nurse to follow-up if the patient does not read the email 722. In some embodiments, the email 722 can be a secure email.

FIG. 7D illustrates another user interface 730 viewed by a nurse using a triage device, such as the one or more triage devices 730. In some embodiments, the data from the patient and/or the nurse is copied to the EMR system 110 with a single click of an input device (e.g., a mouse). In some embodiments, the data is copied as a web or telephone encounter note 732 and stored within the EMR system 110. This can reduce documentation time for the nurse. In certain embodiments, the insight engine sever 140 formats the web or telephone encounter note 732 like a regular EMR note so nurses or practitioners can skim the web or telephone encounter note 732 before the visit and enter the exam room prepared.

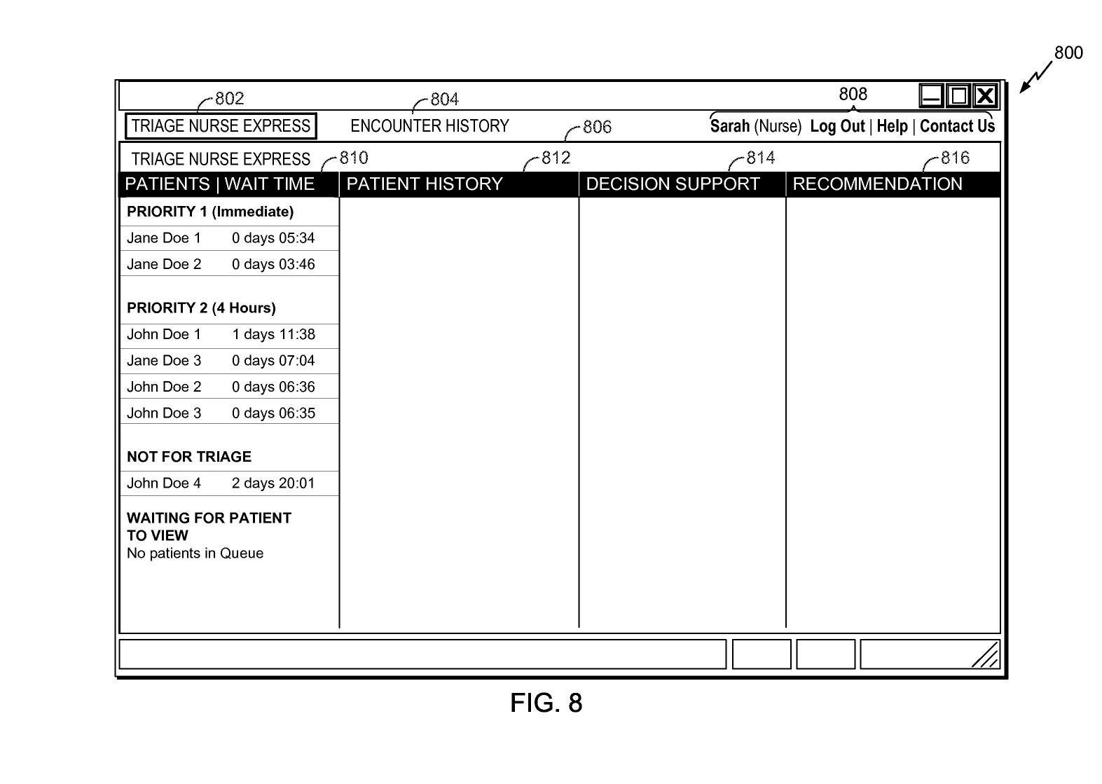

FIG. 8 illustrates a user interface 800 viewed by a nurse using a triage device, such as the one or more triage devices 130, when the nurse accesses the web application executed by the triage nurse express module 320. As illustrated in FIG. 8, the user interface 800 includes triage nurse express button 802, encounter history button 804, patient encounter window 806, and current user and general functions pane 808.

In an embodiment, triage nurse express button 802 loads active encounters when selected. In an embodiment, encounter history button 804 loads triage history reports when selected. As illustrated in FIG. 8, the triage nurse express button 802 is selected.

In an embodiment, the patient encounter window 806 is displayed when the triage nurse express button 802 is selected. The patient encounter window 806 displays pertinent information and actions a nurse can make regarding active encounters. The pertinent information and actions a nurse can take can be divided into four columns: patients/wait time column 810, patient history column 812, decision support column 814, and recommendation column 816. Patients/wait time column 810 includes a queue of patients, and details and actions for each patient are included in columns 812, 814, and 816.

In an embodiment, current user and general functions pane 808 includes a name of the user currently logged in (e.g., the name of the nurse or “Sarah” as illustrated in FIG. 8), the role of the user (e.g., patient, nurse, etc.), a log out option, a help option, and a “contact us” option. The log out option allows the current user to log out, the help option brings up a list of frequently asked questions (not shown), and the “contact us” option can provide contact and support information for the administrator of the web application, for the hospital, for the administrators of the hospital, and/or the like.

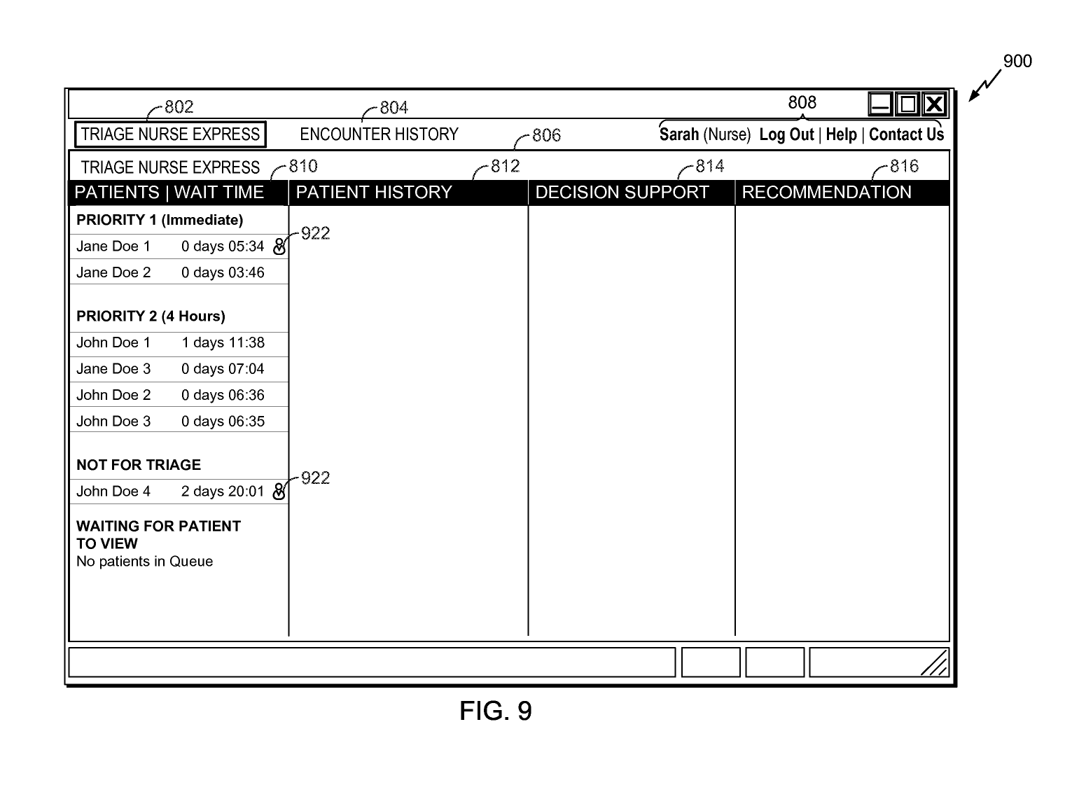

FIG. 9 illustrates another user interface 900 viewed by a nurse using a triage device, such as the one or more triage devices 130, when the nurse accesses the web application executed by the triage nurse express module 320. In an embodiment, after one or more patients have been interviewed (e.g., have completed the survey, answered questions, provided information on reason(s) why they would like to visit a nurse or practitioner, etc.), the insight engine server 140 (e.g., the clinical decision support service module 310) can prioritize or rank each encounter based on its probable urgency (e.g., prioritize or rank each patient based on the urgency of their respective medical issues).

Patients can be organized into one or more priority lists. For example, patients can be organized into an immediate priority list (e.g., priority 1) when the clinical decision support service module 310 flags or classifies the encounters as possibly emergent. In some embodiments, over 75% of cases coded as priority 1 are reclassified by nurses as urgent instead of emergent after review and speaking with the patient.

As another example, patients can be organized into a second priority list (e.g., priority 2) when the clinical decision support service module 310 flags or classifies the encounters as urgent through home care. In some embodiments, the clinical decision support service module 310 defaults to a four-hour response-time policy. However, this is not meant to be limiting as the clinical decision support service module 310 can default to any length of time for the response-time policy.

As another example, patient scan be organized into a third priority list (e.g., not for triage) when the clinical decision support service module 310 flags or classifies the encounters as not requiring triage. For example, perhaps the patient has merely asked for information, like office hours, or has asked for a prescription refill.

In some embodiments, within each clinical decision support service module 310 assigned priority queue, the nurse can see each patient by name. Beside each patient name can be the length of time that encounter has been waiting in the queue. This can help the nurse prioritize patients who have been waiting longer over patients who have just entered or indicated that they seek attention.

In some embodiments, a special queue (e.g., waiting for patient to view) can be used to track whether emails, such as the email 722, have not been read. In some embodiments, after a nurse has emailed a recommendation to a patient, the record appears in the special queue until the patient opens the email for reading. This can allow the nurse to follow-up by other means if a recommendation has not been read for a set number of hours.

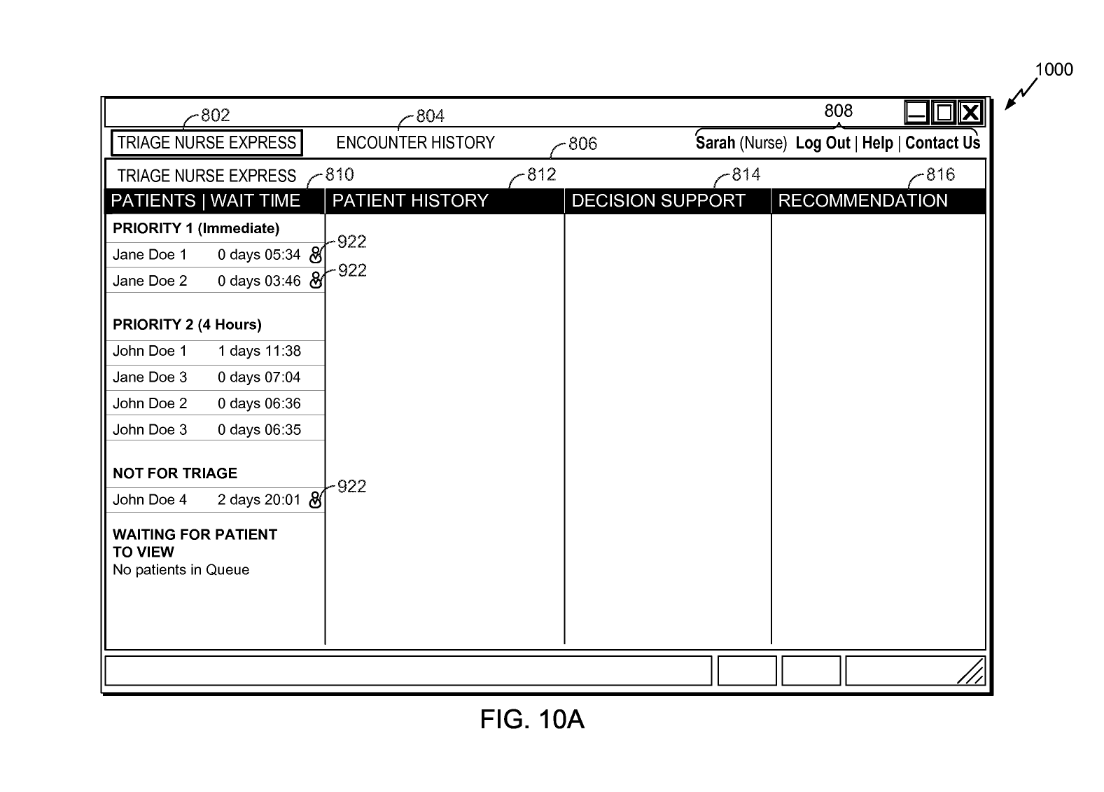

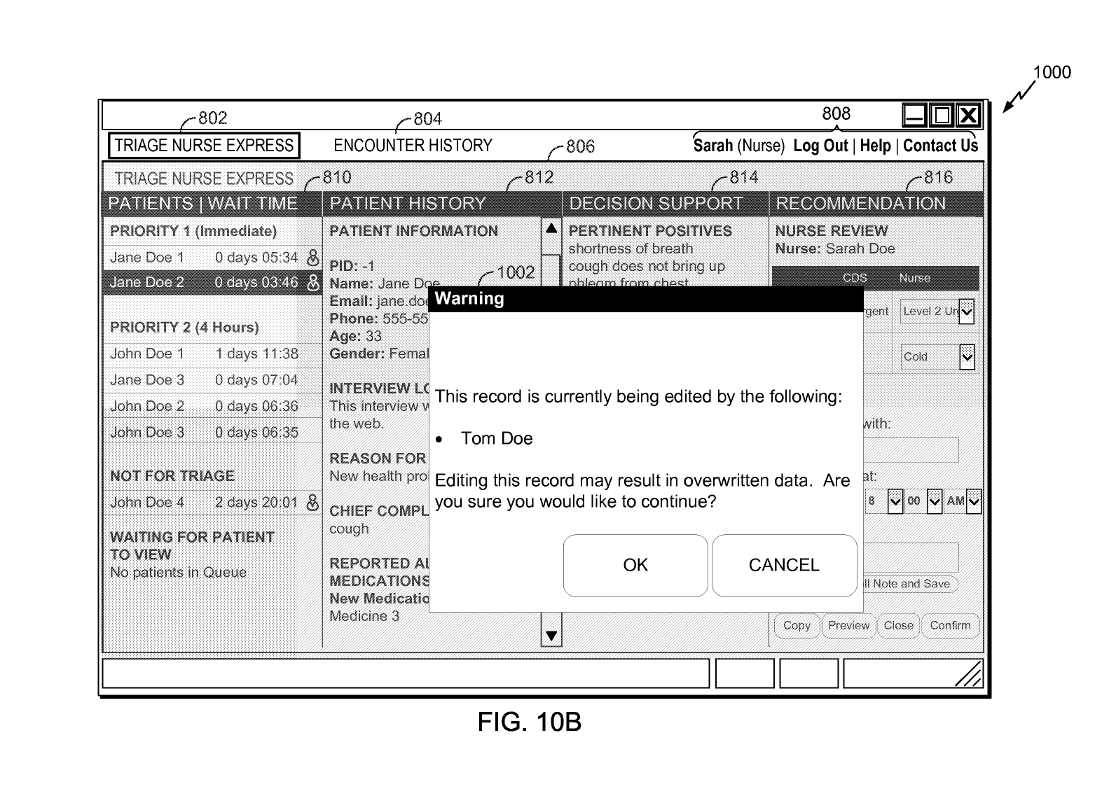

In some embodiments, if another nurse is viewing a patient record, a small icon 922 appears by the patient's name. If a nurse selects a patient record being viewed by another nurse, a message can appear indicating which nurse or practitioner is viewing the patient record. For example, FIGS. 10A-10B illustrate another user interface 1000 viewed by a nurse using a triage device, such as the one or more triage devices 130, when the nurse accesses the web application executed by the triage nurse express module 320. As illustrated in FIG. 10A, icon 922 is placed next to three patient records, Jane Doe 1, Jane Doe 2, and John Doe 4. This indicates that other nurses are viewing these patient records. As illustrates in FIG. 10B, when the patient record for Jane Doe 2, for example, is selected, message 1002 appears. Message 1002 indicates that the patient record for John Doe 2 is being viewed and/or edited by user Tom Doe and asks whether the current user (e.g., Sarah) would like to view and/or edit the record anyway. Note that if the current user selects the option to view the Jane Doe 2 patient record, any changes made to this record could be overwritten by Tom Doe or any changes made by Tom Doe could be overwritten by the current user.

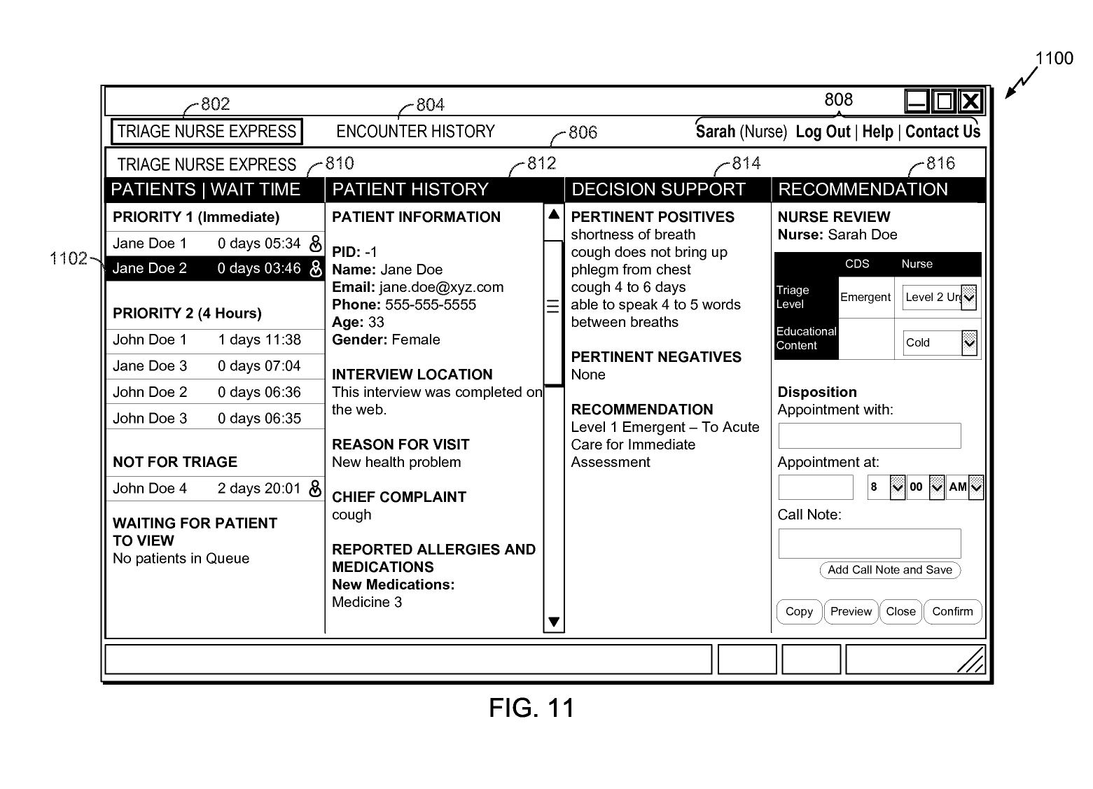

FIG. 11 illustrates another user interface 1100 viewed by a nurse using a triage device, such as the one or more triage devices 130, when the nurse accesses the web application executed by the triage nurse express module 320. In some embodiments, when a patient enters the patient queue in patients/wait time column 810, the interview results are reviewed first by the nurse. In order to review the interview results, the nurse can select a patient record in the patient queue in patients/wait time column 810. For example, as illustrated in FIG. 11, the current user has selected the patient record for Jane Doe 2 as evidenced by the highlighted box 1102.

In an embodiment, upon selecting the patient record for Jane Doe 2, columns 812, 814, and 816 are filled in with the relevant information. For example, the relevant information can be retrieved from the EMR system 110, the knowledge database 160, the online nurse advice module 315, and/or other external sources.

In some embodiments, the decision support column 814 lists the reasons why the clinical decision support service module 310 categorizes this encounter with a particular priority level. For example, in the case illustrated in FIG. 11, “shortness of breath” and “able to speak 4 to 5 words between breaths” means that the clinical decision support service module 310 coded this case as a possible emergent case. This can be reflected in the recommendation of “Level 1 Emergent” at the bottom of the decision support column 814.

In some embodiments, patient demographic and contact information are at the top of the patient history column 812. This can be helpful for quick reference in the case of possible emergency.

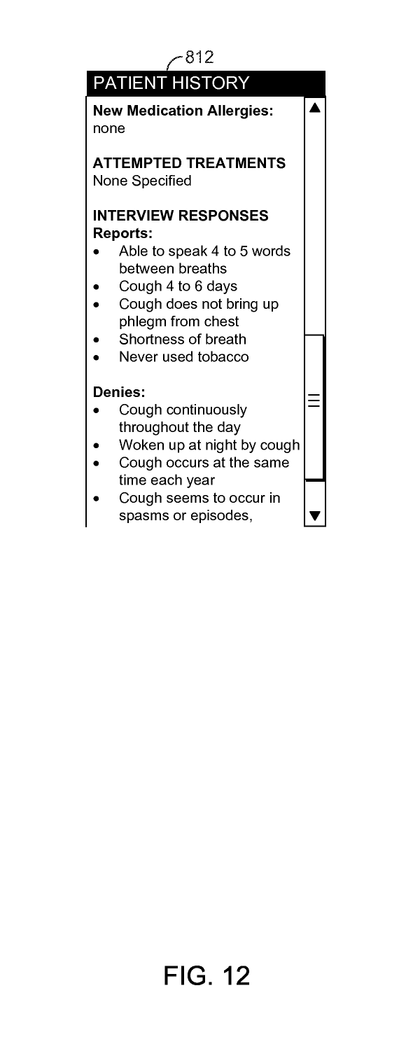

FIG. 12 illustrates a more detailed view of the patient history column 812. In certain embodiments, the patient history column 812 also includes the results of the automated patient interview, including chief complaint, treatments attempted, medications listed, and/or symptoms affirmed and symptoms denied, among others. The affirmations can be shown in a different color (e.g., red) to facilitate quick reading.

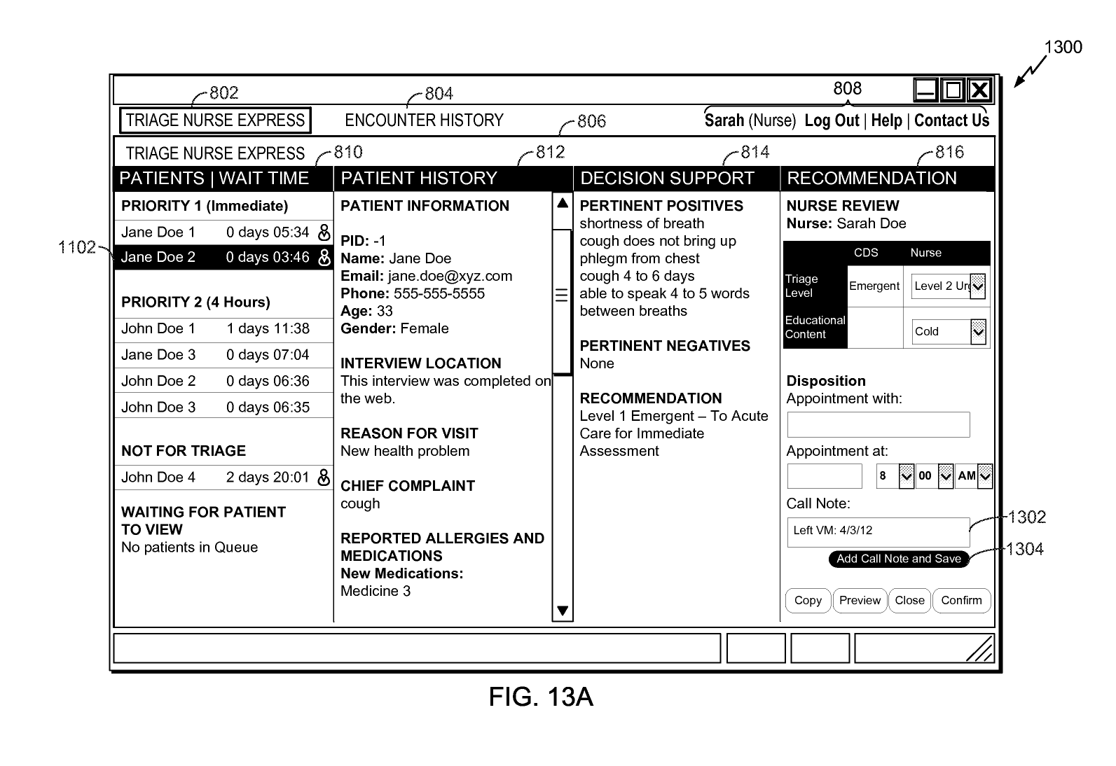

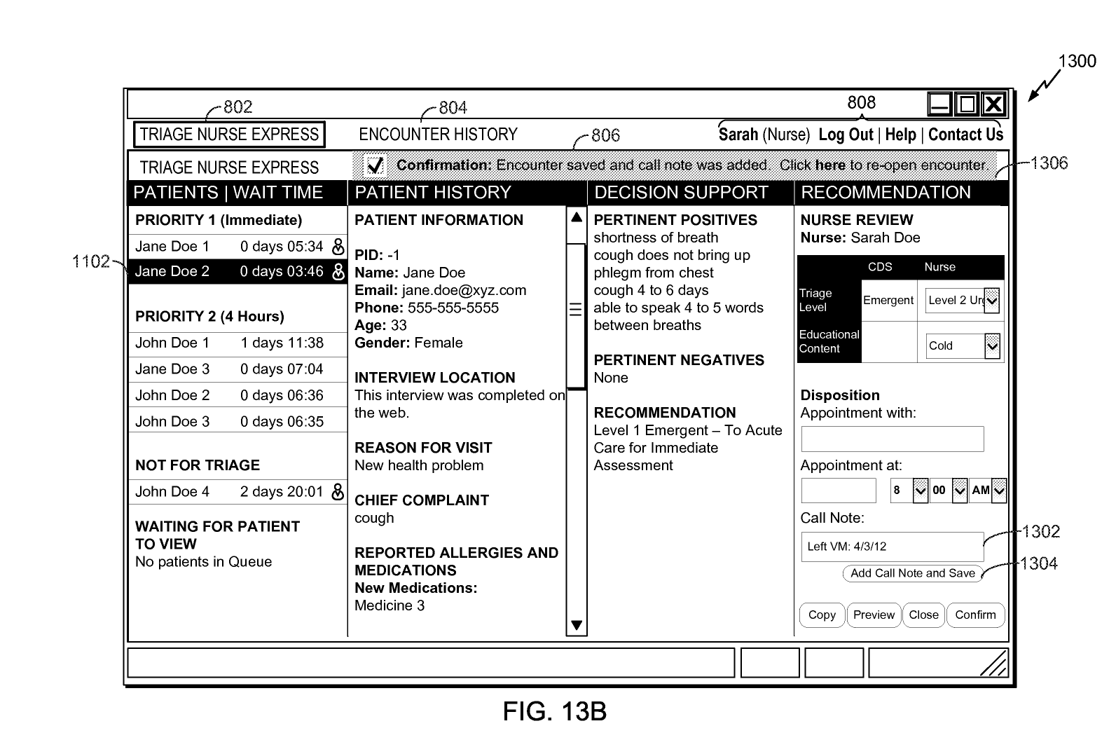

FIGS. 13A-13B illustrate another user interface 1300 viewed by a nurse using a triage device, such as the one or more triage devices 130, when the nurse accesses the web application executed by the triage nurse express module 320. In some embodiments, after reviewing the information presented in columns 810, 812, 814, and/or 816, the current user can call the patient being viewed before making a recommendation.

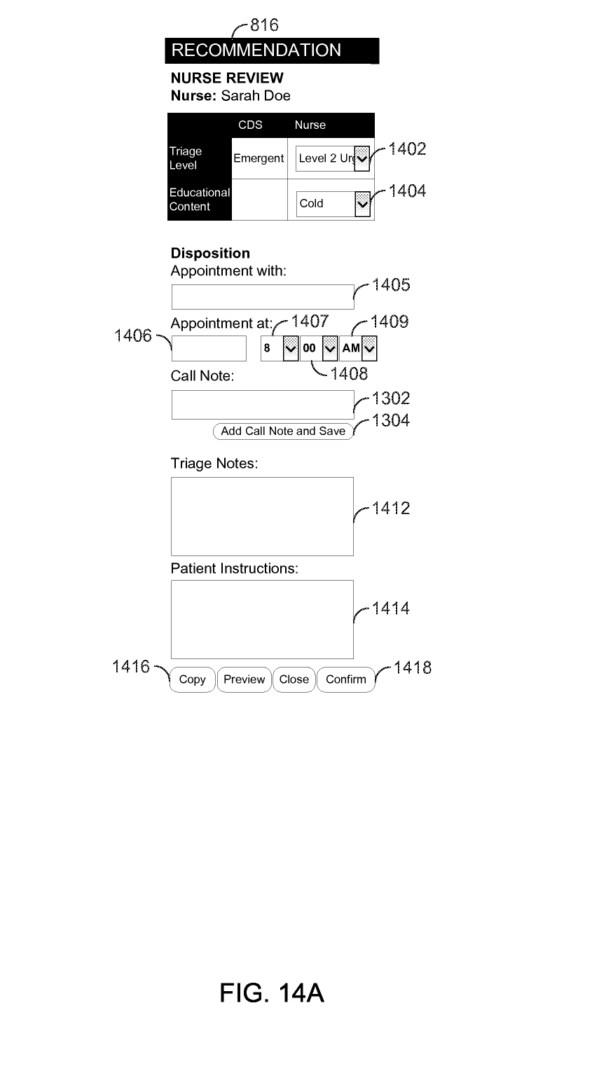

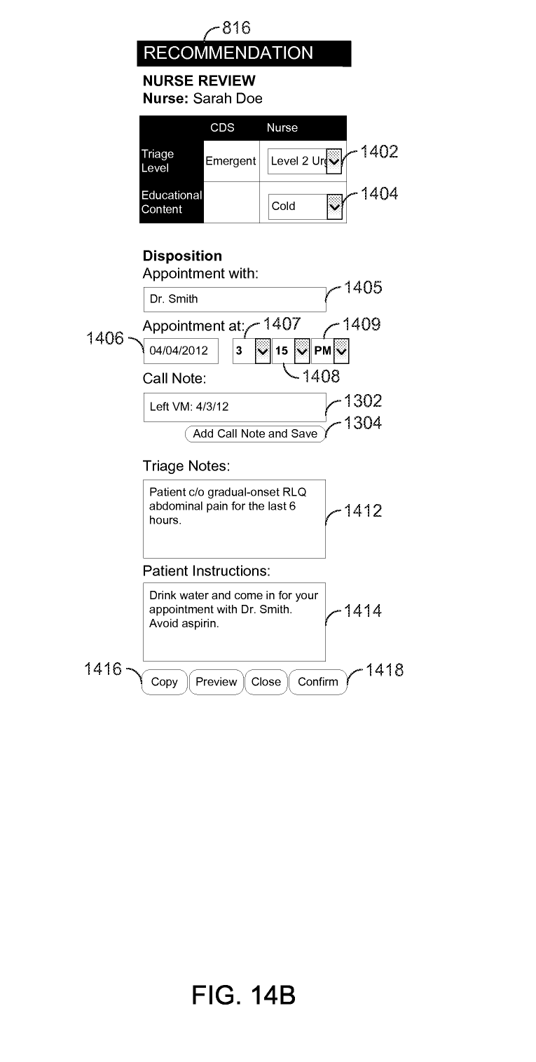

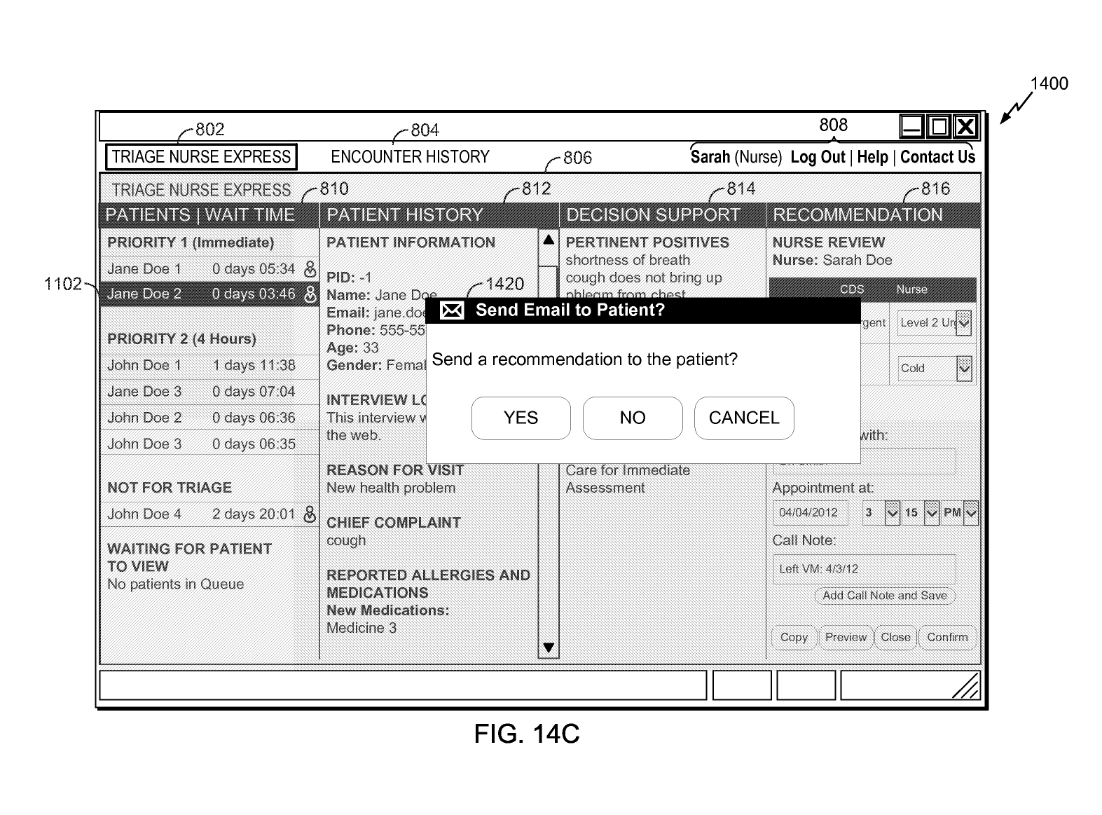

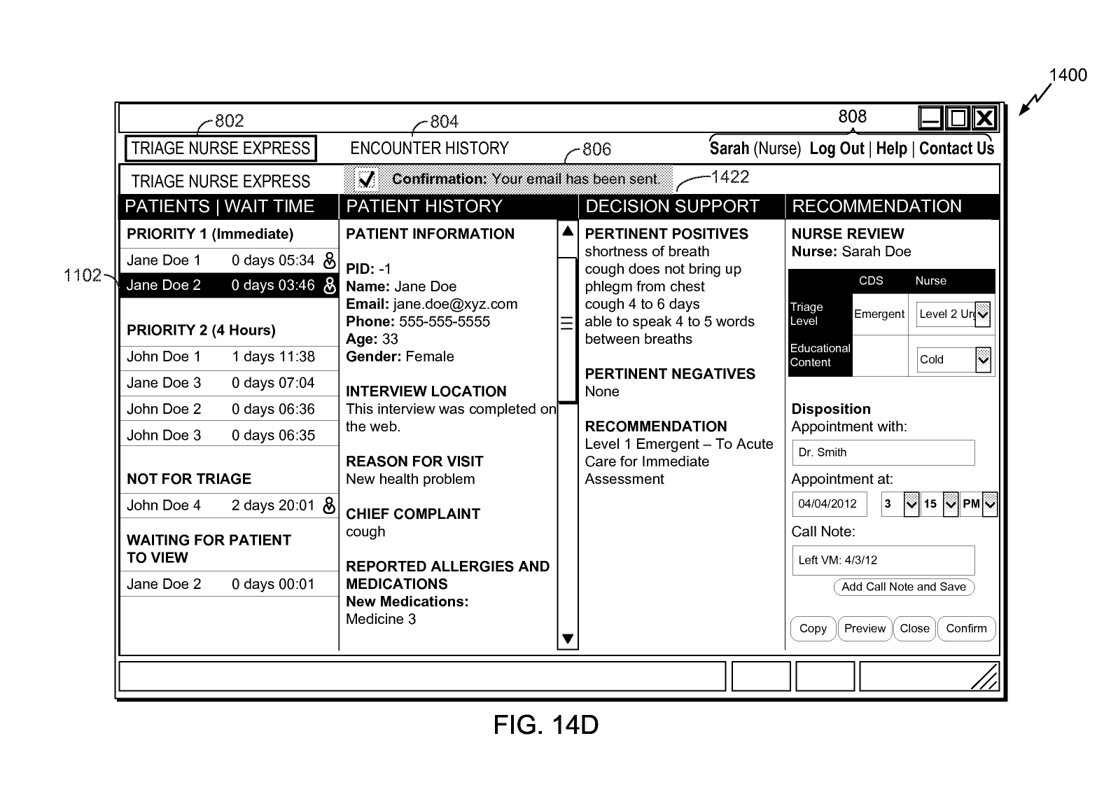

In an embodiment, if the patient is reached, notes about the call can be written and stored in a triage note box 1412 (see FIGS. 14A-14B). Furthermore, instructions or other information can be sent to the patient in an electronic communication (e.g., text message, email, etc.) via a patient instructions box 1414 (see FIGS. 14A-14B). In an embodiment, if a patient is not reached, notes indicating that the patient was contacted and/or that a message was left for the patient can be indicated in call note box 1302. The note can be stored by the insight engine server 140 and/or sent and stored in the EMR system 110 by selecting the add call note and save button 1304.

As illustrated in FIG. 13B, once the add call note and save button 1304 is selected, a confirmation message 1306 appears confirming that the note was saved. In an embodiment, if the confirmation message 1306 is selected, the note and/or other information related to the encounter is displayed in the user interface 1300.

FIGS. 14A-14B illustrate a more detailed view of the recommendation column 816. In some embodiments, once the current user is ready to send the patient a message and record the encounter (e.g., in the EMR system 110, the third party server 170, the insight engine server 140, Medicat, etc.), the current user can first enter or select several options. For example, the current user can select the triage level using dropdown box 1402, the current user can select education content to send to the patient using dropdown box 1404, and/or the current user can enter disposition information in fields 1405-1406 and dropdown boxes 1407-1409. Once the information is entered, as illustrated in FIG. 14B, the current user can select the copy button 1416 and/or the confirm button 1418 to store or record the encounter.

FIGS. 14C-14D illustrate another user interface 1400 viewed by a nurse using a triage device, such as the one or more triage devices 130, when the nurse accesses the web application executed by the triage nurse express module 320. In an embodiment, if the current user wishes to send a message to the patient (e.g., a message entered into the patient instructions box 1414), the current user can select the copy button 1416 and/or the confirm button 1418. Upon selecting either button 1416 or 1418, a message 1420 appears in the user interface 1400. In an embodiment, the message 1420 requests confirmation from the current user that the current user would like to send a message to the patient. If the current user confirms that he or she wants to send a message to the patient, the message is sent and a confirmation message 1422 is displayed in the user interface 1400, as illustrated in FIG. 14D.

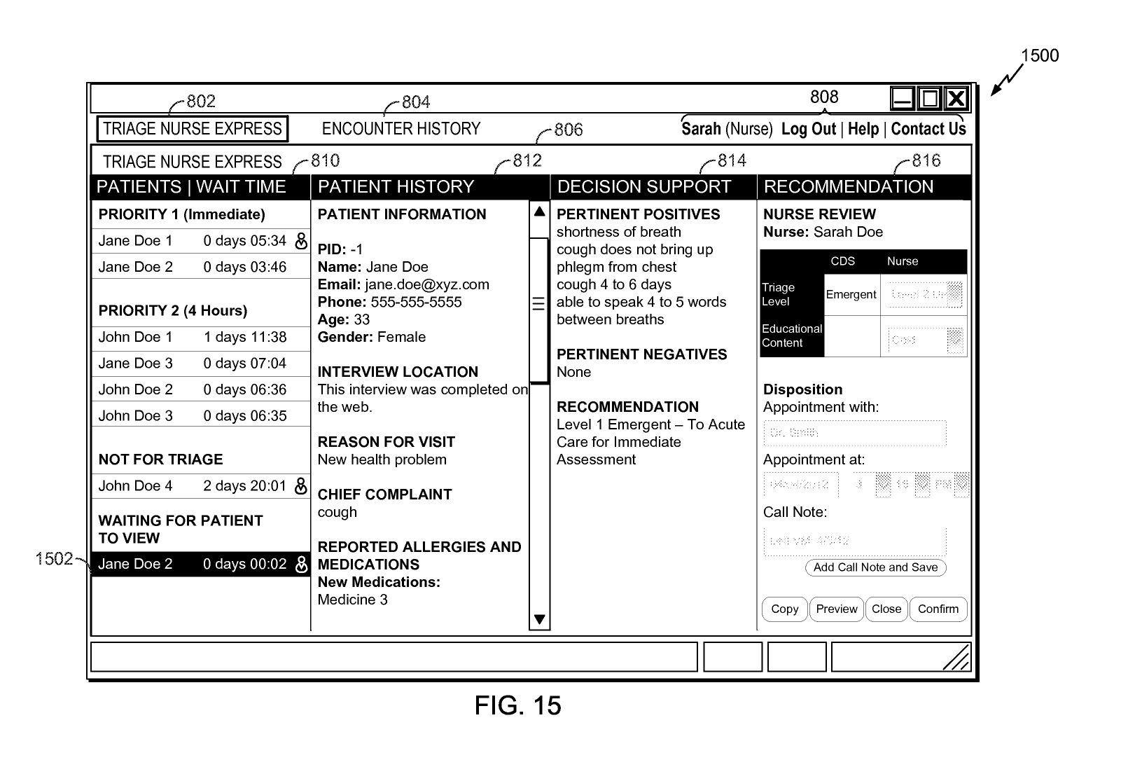

FIG. 15 illustrates another user interface 1500 viewed by a nurse using a triage device, such as the one or more triage devices 130, when the nurse accesses the web application executed by the triage nurse express module 320. In some embodiments, after the current user has sent a patient, such as Jane Doe 2, a message (e.g., text message, email, secure email, etc.), the patient name (e.g., Jane Doe 2) is displayed in the special queue (e.g., the “waiting for patient to view” queue).

As illustrated in FIG. 15, the patient's name can be in a highlighted box 1502 when the patient record associated with the patient is selected. Selecting the patient's name can pull up the patient's records in the user interface 1500. The patient can remain in the special queue until the patient logs in (e.g., logs into the web application executed by the online nurse advice module 315 using the one or more triage devices 130 or the one or more user devices 150) to view the message.

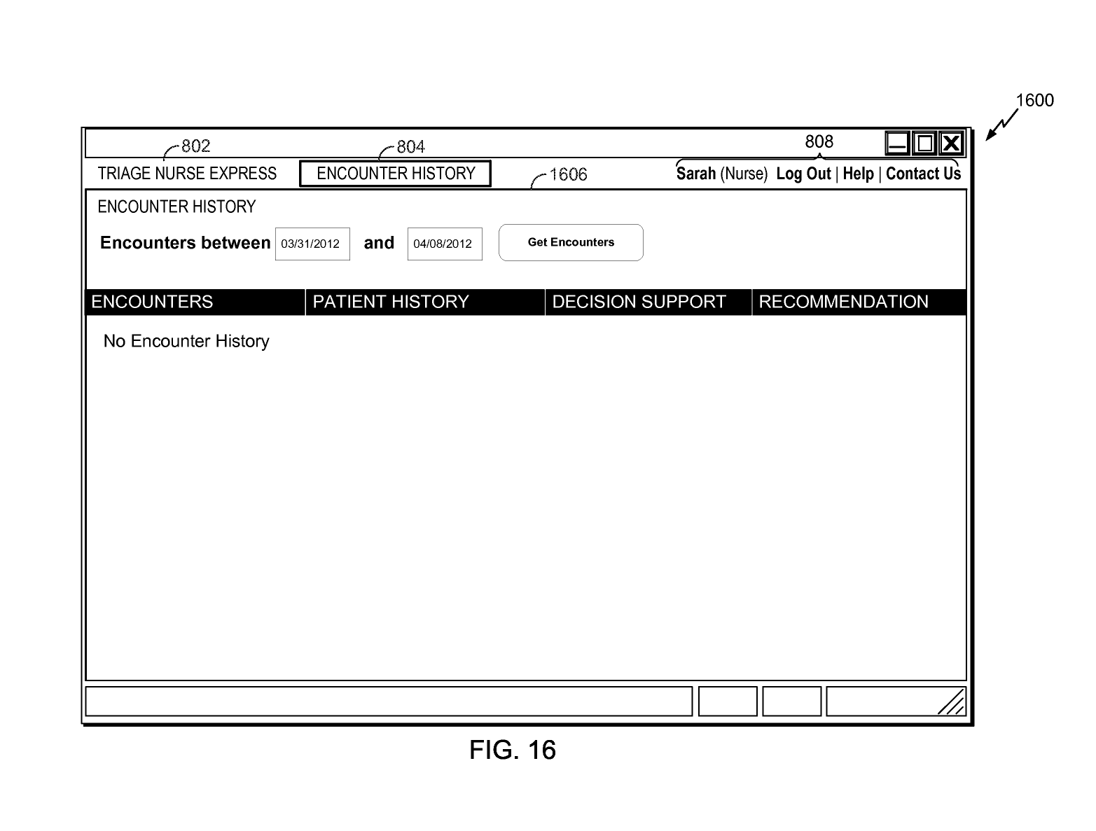

FIG. 16 illustrates another user interface 1600 viewed by a nurse using a triage device, such as the one or more triage devices 130, when the nurse accesses the web application executed by the triage nurse express module 320. As illustrated in FIG. 16, the user interface 1600 includes triage nurse express button 802, encounter history button 804, encounter history window 1606, and current user and general functions pane 808.

In an embodiment, the encounter history window 1606 is displayed when the encounter history button 804 is selected. In some embodiments, nurses can view some or all historical encounters by date range. The historical encounters, if available, can be displayed in a layout that mirrors the layout of the patient queue in the patient encounter window 806.

### Flowchart

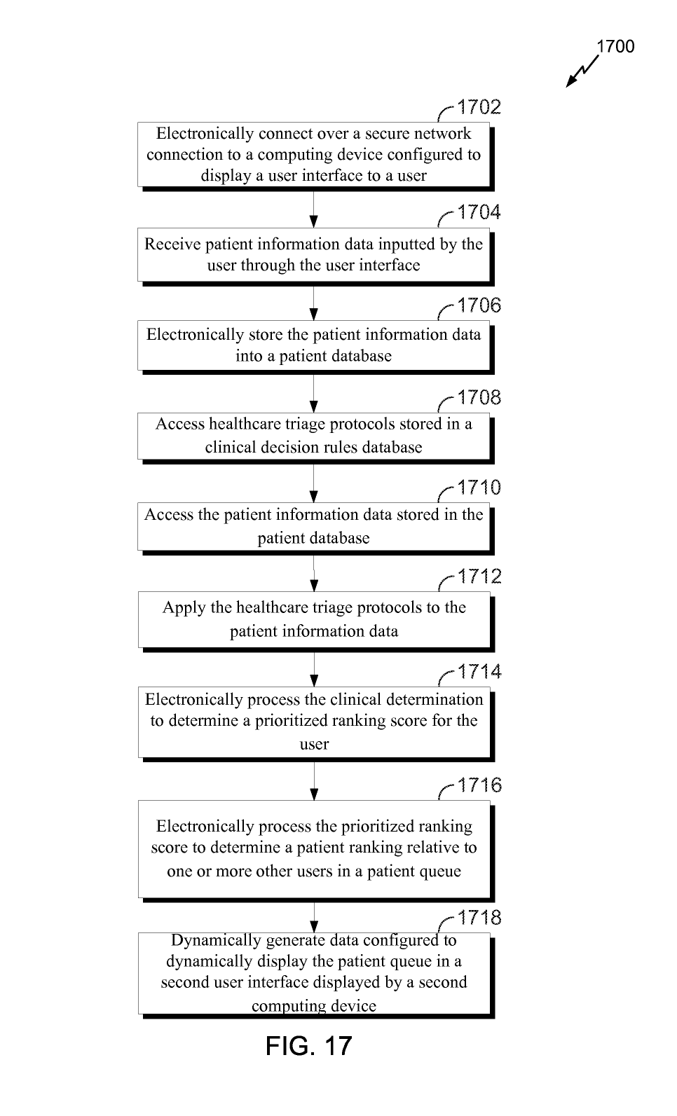

FIG. 17 is a flowchart depicting an embodiment of a process 1700 for automating a triage system. In an embodiment, the process 1700 is performed by the insight engine server 140 of FIG. 1. The process 1700 begins at block 1702. At block 1702, a connection to a computing device configured to display a user interface to a user is established over a secure network connection. In an embodiment, the computing device is a triage device, such as triage device 130, or a user device, such as user device 150, operated by a patient.

At block 1704, patient information data inputted by the user through the user interface is received. In an embodiment, patient information data can include answers provided to a branching list of questions (e.g., a reason for the patient's visit and symptoms experienced by the patient).

At block 1706, the patient information data is electronically stored into a patient database. At block 1708, healthcare triage protocols stored in a clinical decision rules database is accessed. In an embodiment, the clinical decision rules database is the knowledge database 160. In a further embodiment, the healthcare triage protocols are configured to solicit patient information data and to provide clinical determinations.

At block 1710, the patient information data stored in the patient database is accessed. At block 1712, the healthcare triage protocols are applied to the patient information data. In an embodiment, application of the healthcare triage protocols generates patient inquiries and a clinical determination.

At block 1714, the clinical determination is electronically processed to determine a prioritized ranking score for the user. At block 1716, the prioritized ranking score is electronically processed to determine a patient ranking relative to one or more other users in a patient queue.

At block 1718, data is dynamically generated to dynamically display the patient queue in a second user interface displayed by a second computing device. In an embodiment, the second computing device is a triage device, such as triage device 130, operated by a nurse. In a further embodiment, the data is dynamically generated and the display is dynamically updated such that the display of the patient queue is automatically updated as the patient ranking is updated and/or as the patient information data is updated.

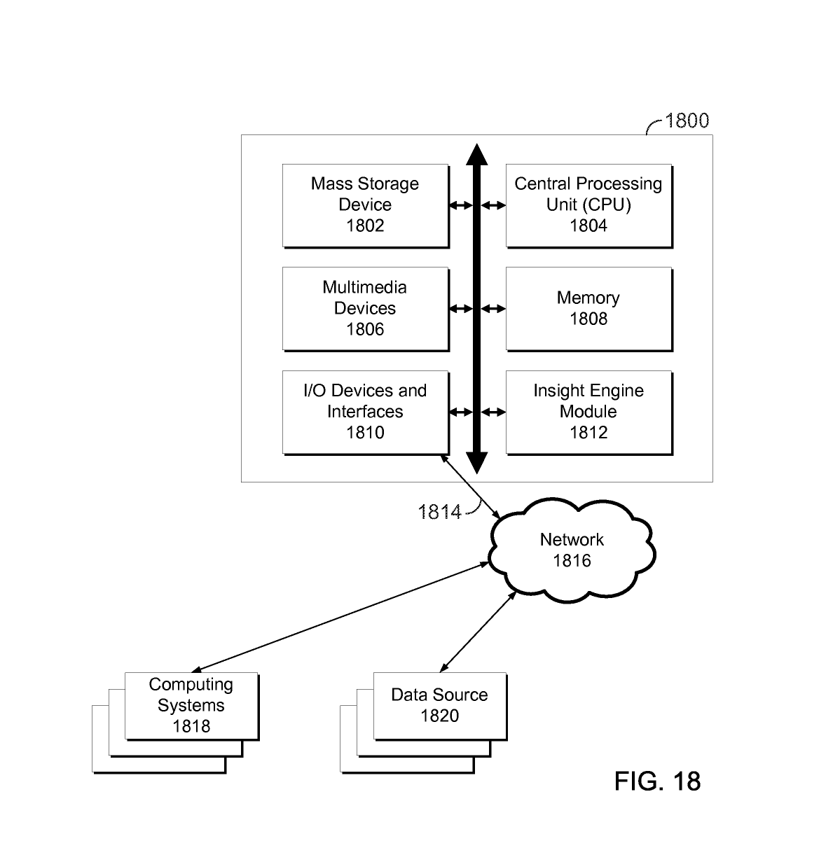

FIG. 18 is block diagram depicting an embodiment of a more detailed device 1800 of the communications system 100 of FIG. 1. In an embodiment, the device 1800 comprises the one or more triage devices 130, the one or more user devices 150, the third party server 170, and/or the insight engine server 140. As illustrated in FIG. 18, the device 1800 can include a mass storage device 1802, a central processing unit (CPU) 1804, multimedia devices 1806, a memory 1808, input/output (I/O) devices and interfaces 1810, and/or an insight engine module 1812. The insight engine module 1812 can carry out the functions, methods, and/or processes described herein. For example, the insight engine module 1812 can carry out the functions and processes described herein with respect to FIGS. 1-17 to automatically triage patients. The insight engine module 1812 is executed on the device 1800 by the CPU 1804, as described in more detail below.

In general the word “module,” as used herein, refers to logic embodied in hardware or firmware or to a collection of software instructions, having entry and exit points. Modules are written in a program language, such as JAVA, JavaScript, HTML, XML, CSS, AJAX, PHP, C, C#, or C++, or the like. Software modules can be compiled or linked into an executable program, installed in a dynamic link library, or can be written in an interpreted language such as BASIC letters, ASP, PERL, LUA, PHP, Ruby, Python, or the like. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems, and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

The device 1800 includes one or more CPUs 1804, which can include a microprocessor. The device 1800 further includes the memory 1808, such as random access memory (RAM) for temporary storage of information, a read only memory (ROM) for permanent storage of information, and the mass storage device 1802, such as a hard drive, a flash drive, a memory card, a diskette, an optical media storage device, or the like. Alternatively, the mass storage device 1802 can be implemented in an array of servers. Typically, the components of the device 1800 are connected to the computer using a standards based bus system. The bus system can be implemented using various protocols, such as Peripheral Component Interconnect (PCI), Micro Channel, SCSI, Industrial Standard Architecture (ISA) and Extended ISA (EISA) architectures.

The device 1800 includes one or more I/O devices and interfaces 1810, such as a keyboard, mouse, touchpad, and printer. The I/O devices and interfaces 1810 can include one or more display devices, such as a monitor, that allows the visual presentation of data to a user. More particularly, a display device provides for the presentation of GUIs as application software data, and multi-media presentations, for example. The I/O devices and interfaces 1810 can also provide a communications interface to various external devices. The device 1800 can include one or more multimedia devices 1806, such as speakers, video cards, graphics accelerators, microphones, and/or the like.

The device 1800 can run on a variety of computing devices, such as a server, a virtual server, a Windows server, and Structure Query Language server, a Unix Server, a Linux Server, a Mac Server, a personal computer, a laptop computer, and so forth. In other embodiments, the device 1800 can run on a mainframe computer suitable for controlling and/or communicating with large databases, performing high volume transaction processing, and generating reports from large databases. The device 1800 is generally controlled and coordinated by an operating system software, such as z/OS, Windows 95, Windows 98, Windows NT, Windows 2000, Windows XP, Windows Vista, Windows 7, Linux, Unix, BSD, SunOS, Solaris, tinyOS, iOS, Windows Mobile, Android, webOS, or other compatible operating systems, including proprietary operating systems. Operating systems control and schedule computer processes for execution, perform memory management, provide file system, networking, and I/O services, and provide a user interface, such as a graphical user interface (GUI), among other things.

The device 1800 can communicate with a network 1816 via communication link 1814 (wired, wireless, or a combination thereof). In an embodiment, the network 1816 is the network 120 of FIG. 1. The network 1816 communicates with various computing devices and/or other electronic devices. For example, the network communicates with the device 1800, computing systems 1818, and/or data source 1820. In an embodiment, the computing systems 1818 can be any of the devices or servers of the communications system 100 of FIG. 1. In a further embodiment, the data source 1820 can be the knowledge database 160 and/or any other database described herein. The insight engine module 1812 can access or can be accessed through a web-enabled user access point. Connections can be a direct physical connection, a virtual connection, and other connection type. The web-enabled user access point can include a browser module that uses text, graphics, audio, video, and other media to present data and to allow interaction with data via the network 1816. The browser module can display media associated with an application as well.

The browser module or other output module can be implemented as a combination of an all-points addressable display such as a cathode ray tube (CRT), a liquid crystal display (LCD), a plasma display, a field emission display (FED), a surface-conduction electron-emitter display (SED), a light-emitting diode display (LED), an organic light-emitting diode display (OLED), an active-matrix organic light-emitting diode display (AMOLED), or other types and/or combinations of displays. The output module can be implemented to communicate with I/O devices and interfaces 1810 and they also include software with the appropriate interfaces which allow a user to access data through the use of stylized screen elements, such as menus, windows, dialogue boxes, tool bars, and controls (e.g., radio buttons, check boxes, sliding scales, and so forth). Furthermore, the output module can communicate with a set of input and output devices to receive signals from the user.

### Benefits

In some embodiments, a patient can get a response quicker than visiting the doctor. In certain embodiments, an average of about 10 minutes to answer questions and about 3 minutes talking to nurse yields about 13 minutes for Online Triage. In some embodiments, the total time for a patient to answer questions and talk to a nurse for Online Triage can be between about 5 minutes and about 25 minutes, or any other length of time. In certain embodiments, even when a visit is needed, a patient can receive education and assurance quicker than alternatives. On the other hand, studies show that an average wait time before a patient sees a doctor is about 23 minutes (and the average wait time is getting longer over time) and the average time spent with the doctor is about 18 minutes. The average ER stay is far worse, clocking in at about 4 hours and 7 minutes.

Studies further show that the median cost is about $406 for emergency room services and about $89 for a visit to the family physician. If patient care is redirected from the emergency department (ED) to private practice, the systems and methods described herein can save the patient about $317. If patient care is redirected from family practice to home care, the systems and methods described herein can save patients about $89. Accordingly, if patient care is redirected from ED to home care, the savings are about $406.

In some embodiments, the average nurse triage time per encounter decreases from about 12-15 mins to 5 mins with the systems and methods described herein, saving about 8 minutes on average. In certain embodiments, the nurse triage time per encounter decreases by between about 1 minute and 12 minutes, or any other length of time.

In some embodiments, the systems and methods described herein save providers about 3 minutes per triaged visit. In certain embodiments, provider time per triaged visit is saved by between about 1 minute and 20 minutes, or any other length of time. With greater documentation, the doctor has more information on the reason(s) for a visit by the patient. Providers can also avoid many unneeded and merely informational visits.

Studies show that the industry standard return on investment (ROI) for telephone triage is about $2-4 for every $1 invested. Telephone triage, along with disease management programs, has the greatest immediate impact of all wellness programs on reducing healthcare claims. This is due to the education of the patient on what is appropriate care. If, for example, a patient has a condition that is getting rapidly worse over time, the appropriate care may be to get them in to a doctor right away, to an urgent clinic, or, if need be, to an emergency room (ER). Doing so can save money by keeping the patient out of a lengthy hospital stay while he or she recovers. On the other hand, for problems that can easily wait, directing patients to make an appointment with their doctor can save money by directing them to a lower cost option when their situation is not emergent. Studies indicate that less than a quarter of those who were inclined to visit the emergency room still go after discussing their symptoms with a nurse.

The system and methods described herein could bring about $300,000 annual savings due to utilization benefits for 2 disease categories in some embodiments.

### Other Embodiments

Most of the implementation details described herein are for the preferred embodiment. There are other ways of implementing the system. In other embodiments, it's possible to change the medium or device through which information is gathered. For example, the insight engine server 140 may collect information from the patient through a mobile app, kiosk, or other device.

Additionally, in certain embodiments, information may be collected through an intermediary including but not limited to caregivers or case managers. The intermediary may guide the patient in data entry, or enter the data on behalf of the patient. They may interact with the patient directly in person or through another communication channel such as a telephone or secure message.

In some embodiments, different protocols for the interview can also be used, including Wolter's Kluwer's Telephone Triage for Nurses or others. The interview protocols can also be created or customized by the insight engine server 140 or the client such as to modify it for their patient population, standard of care, or other reason. In addition to the interview protocols, the decision support protocols can also be customized in a similar way. The customization can be done directly by via the insight engine server 140 or the client can use a self-service tool to edit them among other methods.

In certain embodiments, patient encounters can also be answered directly by a nurse without using a queue, such as in the case of live chat. In some embodiments, the encounters need not be sent to the triage nurse express module 320, especially if the patients are transferred to another system, including, but not limited to, a call center CRM system or electronic health records (EHRs) or EMR queue. In other embodiments, it is also not necessary to always show summary information to the nurse as some providers may wish to see the full set of data. The summary can be generated using a variety of criteria, including, but not limited to, the protocol acuity rules. The summary can summarize information aggregated from multiple sources, including the EHR, PMS, or other sources. Flagging of information is also optional and can occur through many different kinds of criteria, including the protocol rules. Flagging can be communicated through many types of visual or other medium, including highlighting, sorting, audio, or others.

In other embodiments, the nurse can communicate back to the patient through multiple channels including telephone, secure message, SMS, email, direct contact, or others. In some embodiments, it is optional for the system to track whether the patient has read the message. There are other methods and criteria to track whether the patient has read the message, such as by asking the patient for confirmation, tracking the user's mouse clicks, or other methods.

In some embodiments, the review by the nurse can happen in different places in the process. Some practices may wish to use queues and emergency screening, and some may wish to forward the encounter directly to a nurse. The client may wish to use outbound contact (initiated by either the nurse or the system) to patients to follow up on a recent hospital discharge or other criteria, which may trigger an interview which may or may not transition into triage when the patient reports a problem. Nurses or other care workers may use the tool, for example, if they are working at a skilled nursing facility, home care, or even in the emergency department, among others.

In certain embodiments, it is not necessary to integrate with the HER or EMR system 110. It is also possible to get information about the patient's history directly from the patient in the interview or from other sources. It is also possible to output the data to a variety of sources, including CRM systems, fax, databases, or others.

Information collected, insights, rules, and knowledge bases are not limited to triage and may relate to pre-visit information, prescription refills, appointment requests, and others.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although the embodiments of the inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combine with or substituted for one another in order to form varying modes of the disclosed inventions. Thus, it is intended that the scope of the present inventions herein disclosed should not be limited by the particular disclosed embodiments described above.

What is claimed is:

1. An automated triage system, comprising:
a patient database configured to store patient information data;
a patient information system configured to receive patient information data from a user interface, the patient information system comprising:
a user interface module configured to electronically connect over a secure network connection to a computing device configured to display the user interface to a patient, the user interface module configured to cause display of patient inquiries and to receive patient information data inputted by the patient though the user interface, the user interface module configured to electronically store the patient information data into the patient database;
a clinical decision rules database comprising healthcare triage protocols configured to solicit patient information data and to provide clinical determinations;
a data processing engine configured to access the healthcare triage protocols stored in the clinical decision rules database and to access the patient information data stored in the patient database and to apply the healthcare triage protocols to the patient information data to generate patient inquiries and to generate a clinical determination;
a prioritized ranking system configured to electronically process the clinical determination to determine a prioritized ranking score for the patient;
a nurse control panel system configured to electronically process the prioritized ranking score to determine a patient ranking relative to one or more other patients in a patient queue, the nurse control panel system configured to cause dynamic display of the patient queue, the nurse control panel system configured to access the patient database to cause display of patient information data of the patient.

2. The automated triage system of claim 1, wherein the nurse control panel system is further configured to cause display of the patient information data of the patient adjacent to the patient queue.

3. The automated triage system of claim 1, wherein the patient ranking is further determined based on a workload of one or more nurses accessing the nurse control panel system.

4. The automated triage system of claim 1, wherein the nurse control panel system is configured to be accessed by one or more nurses.

5. The automated triage system of claim 1, wherein the clinical determination is based on the healthcare triage protocols soliciting additional patient information data.

6. The automated triage system of claim 1, further comprising:
a healthcare provider database configured to electronically store healthcare provider information data;
a healthcare provider recommendation engine configured to electronically process the clinical determination to generate a healthcare provider recommendation based on accessing the healthcare provider database to determine a healthcare provider with an office that is near the patient and that can handle the clinical determination of the patient.

7. A computer-implemented method of automating a triage system, the computer-implemented method comprising:
as implemented by one or more computer systems comprising computer hardware and memory, the one or more computer systems configured with specific executable instructions,
electronically connecting over a network connection to a computing device configured to display a user interface to the user;
receiving patient information data inputted by the user though the user interface;
electronically storing the patient information data into a patient database;
accessing healthcare triage protocols stored in a clinical decision rules database, wherein the healthcare triage protocols are configured to solicit patient information data and to provide clinical determinations;
accessing the patient information data stored in the patient database;
applying the healthcare triage protocols to the patient information data, wherein application of the healthcare triage protocols generates patient inquiries and a clinical determination;
electronically processing the clinical determination to determine a prioritized ranking score for the user;
electronically processing the prioritized ranking score to determine a patient ranking relative to one or more other users in a patient queue; and
dynamically generating data to dynamically display the patient queue in a second user interface displayed by a second computing device.

8. The computer-implemented method of claim 7, further comprising transmitting the dynamically generated data to the second computing device.

9. The computer-implemented method of claim 7, further comprising generating second data to display the patient information data of the patient adjacent to the patient queue.

10. The computer-implemented method of claim 7, wherein the patient ranking is further determined based on a workload of one or more nurses.

11. The computer-implemented method of claim 7, wherein the one or more nurses access the patient queue.

12. The computer-implemented method of claim 7, wherein the clinical determination is further based on the healthcare triage protocols soliciting additional patient information data.

13. The computer-implemented method of claim 7, further comprising:
electronically storing healthcare provider information data;
electronically processing the clinical determination to generate a healthcare provider recommendation based on accessing the healthcare provider database to determine a healthcare provider with an office that is near the user and that can handle the clinical determination of the user.

14. A non-transitory computer-readable medium comprising one or more program instructions recorded thereon, the instructions configured for execution by a computing system comprising one or more processors in order to cause the computing system to:
electronically connect over a network connection to a computing device configured to display a user interface to the user;
receive patient information data inputted by the user though the user interface;
electronically store the patient information data into a patient database;
access healthcare triage protocols stored in a clinical decision rules database, wherein the healthcare triage protocols are configured to solicit patient information data and to provide clinical determinations;
access the patient information data stored in the patient database;
apply the healthcare triage protocols to the patient information data;
generate patient inquiries and a clinical determination based on application of the healthcare triage protocols to the patient information data;
electronically process the clinical determination to determine a prioritized ranking score for the user;
electronically process the prioritized ranking score to determine a patient ranking relative to one or more other users in a patient queue; and
dynamically generate data to dynamically display the patient queue in a second user interface displayed by a second computing device.

15. The medium of claim 14, wherein the instructions are further configured to cause the computing system to transmit the dynamically generated data to the second computing device.

16. The medium of claim 14, wherein the instructions are further configured to cause the computing system to generate second data to display the patient information data of the patient adjacent to the patient queue.

17. The medium of claim 14, wherein the patient ranking is further determined based on a workload of one or more nurses.

18. The medium of claim 14, wherein the one or more nurses access the patient queue.

19. The medium of claim 14, wherein the instructions are further configured to cause the computing system to generate the clinical determination based on the healthcare triage protocols soliciting additional patient information data.

20. The medium of claim 14, wherein the instructions are further configured to cause the computing system to:
electronically store healthcare provider information data;
electronically process the clinical determination to generate a healthcare provider recommendation based on accessing the healthcare provider database to determine a healthcare provider with an office that is near the user and that can handle the clinical determination of the user.
